(19) United States
(12) Patent Application Publication
(10) Pub. No.: US 2015/0015581 A1
(43) Pub. Date: Jan. 15, 2015

(54) Method for Improving Speed and Visual Fidelity of Multi-Pose 3D Renderings

(71) Applicant: Google Inc., Mountain View, CA (US)

(72) Inventor: Scott Lininger, Lafayette, CO (US)

(21) Appl. No.: 14/375,799

(22) PCT Filed: Jan. 30, 2013
(86) PCT No.: PCT/US13/23866

§ 371 Date: Jul. 31, 2014

Related U.S. Application Data
(60) Provisional application No. 61/593,105, filed on Jan. 31, 2012.
(60) Provisional application No. 61/593,115, filed on Jan. 31, 2012.
(60) Provisional application No. 61/593,112, filed on Jan. 31, 2012.
(60) Provisional application No. 61/593,109, filed on Jan. 31, 2012.

(51) Int. Cl. G06T 15/20; G06T 11/60; G06T 19/20; G06T 15/60

(52) U.S. Cl. CPC G06T 15/20; G06T 15/60; G06T 11/60; G06T 19/20; G06T 2200/24; G06T 2210/62; G06T 2219/2024
USPC 345/426; 345/419

(57) ABSTRACT

A method and system provides increased visual fidelity in a multi-pose three-dimensional rendering of an object by overlaying edge lines. A server sends a multiplicity of two-dimensional renderings of the object to a client device over a network. Each of the 2D renderings depicts the object in a different pose. As the 2D renderings are displayed sequentially, the object appears to move, for example, by pivoting on an axis. The server also sends a multiplicity of overlay renderings to the client device. Each of the overlay renderings corresponds to a respective one of the 2D renderings and depicts edge lines that would appear on the 2D rendering. The edge lines are rendered on a transparent background such that, when a user interface combines one of the 2D renderings with the corresponding overlay rendering, the edge lines are highlighted on the 2D rendering and provide additional visual cues to the viewer.

### RELATED APPLICATIONS

This application claims the benefit of priority of U.S. Provisional Patent Application Nos. 61/593,105, entitled “Method for Improving Speed an Visual Fidelity of Multi-Pose 3D Renderings By Overlaying Visible Edges”; 61/593,115, entitled “Method for Improving Speed an Visual Fidelity of Multi-Pose 3D Renderings By Overlaying Visible Shadows”; 61/593,112, entitled “Method for Improving Speed an Visual Fidelity of Multi-Pose 3D Renderings By Combining Images”; and 61/593,109, entitled “Method for Improving Speed an Visual Fidelity of Multi-Pose 3D Renderings By Preloading an Optimized Thumbnail View,” each of which was filed on Jan. 31, 2012, and each of which is incorporated by reference, in its entirety and for all purposes, herein.

### FIELD OF THE DISCLOSURE

The present disclosure relates to display in two-dimensions of three-dimensional figures using multi-pose renderings and, more specifically, to a method and system for improving the visual fidelity and speed with which such multi-pose 3D renderings are displayed, by displaying visible edges.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

It is a common desire to display interactive 3D views of objects in software. However, not every computer, operating system, or browser is capable of displaying “true” 3D, either because they have no graphics processing unit (GPU), network bandwidth is too small to allow fast downloading of large 3D assets, or the programming environment does not give access to 3D application programming interfaces (APIs) such as OpenGL® or DirectX®.

Some developers solve this problem by rendering views of 3D objects into 2D images. In its simplest form, a PNG or JPG file might be rendered from a single camera point of view and made available on a web server. If a user is viewing a product details page on a shopping website, the user can at least see a rendering of the product regardless of whether their browser or computer supports real-time 3D.

One step beyond this is an approach wherein an object or model is rendered not just in a single view, but in multiple views. The user is provided a user interface in the browser in which the user can “click and drag” to rotate the object at interactive speeds. Since the multiple views are pre-rendered views of the object from different views, the user can “swivel” the object and see the object from any of the pre-rendered viewing angles, giving the illusion of interactive 3D when, in fact, nothing is changing aside from which of the 2D images is currently displayed.

### SUMMARY

In an embodiment, a computer-implemented method of depicting on a display a multi-pose three-dimensional rendering of an object includes storing on a computer readable medium a multiplicity of two-dimensional renderings of the object. Each of the multiplicity of 2D renderings depicts the object from a different apparent viewing angle. The method also includes transmitting the multiplicity of 2D renderings via a network to a client device coupled to the display. The method further includes storing on the computer readable medium a multiplicity of overlay renderings. Each overlay rendering corresponds to a respective one of the multiplicity of 2D renderings. Each overlay includes edge lines, rendered in a first color and corresponding to the edges of the object as rendered in the corresponding 2D rendering, and a transparent background. The method further includes transmitting the overlay renderings via the network to the client device, and providing an interface operable to display a plurality of composite images, each composite image comprising one of the overlay renderings layered over its corresponding 2D rendering.

In another embodiment, a system for depicting on a display a multi-pose three-dimensional rendering of an object includes a database storing a multiplicity of two-dimensional renderings of the object. Each of the multiplicity of 2D renderings depicts the object from a different apparent viewing angle. The database also stores a multiplicity of overlay renderings, with each overlay rendering corresponding to a respective one of the multiplicity of 2D renderings. Further, each overlay rendering includes edge lines, rendered in a first color and corresponding to the edges of the object as rendered in the corresponding 2D rendering, and a transparent background. The system further includes machine executable instructions stored on a machine readable medium and specifying an interface operable to display a plurality of composite images, each composite image comprising one of the overlay renderings layered over its corresponding 2D rendering. Still further, the system includes a server communicatively coupled to the database via a network and operable to send to a client device communicatively coupled to the network the machine instructions specifying the interface. The server is also operable to receive from the client device a request for the rendering of the object and, in response to the request, to retrieve the multiplicity of 2D renderings and the multiplicity of overlay renderings from the database and transmit the multiplicity of 2D renderings and the multiplicity of overlay renderings to the client device.

In still another embodiment, a machine-readable storage medium has stored thereon a set of machine executable instructions that, when executed cause a processor to receive from a server communicatively coupled to the processor by a network a multiplicity of 2D renderings. Each of the multiplicity of 2D renderings depicts a three-dimensional object from a different apparent viewing angle. The instructions also cause the processor to receive from the server a multiplicity of overlay renderings, each overlay rendering corresponding to a respective one of the multiplicity of 2D renderings. Each overlay rendering includes edge lines rendered in a first color and corresponding to the edges of the 3D object as rendered in the corresponding 2D rendering and a transparent background. Further, the instructions cause the processor to cause a display device coupled to the processor to display a plurality of composite images. Each composite image includes one of the overlay renderings layered over its corresponding 2D rendering.

In an embodiment, a computer-implemented method of depicting on a display a multi-pose three-dimensional rendering of an object includes storing on a computer readable medium a multiplicity of two-dimensional renderings of the object. Each of the multiplicity of 2D renderings depicts the object from a different apparent viewing angle. The method also includes transmitting the multiplicity of 2D renderings via a network to a client device coupled to the display. The method further includes storing on the computer readable medium a multiplicity of overlay renderings. Each overlay rendering corresponds to a respective one of the multiplicity of 2D renderings. Each overlay rendering includes a shadow layer, rendered in a first color and corresponding to the shadows on the object as rendered in the corresponding 2D rendering, and a transparent background. The method further includes transmitting the overlay renderings via the network to the client device, and providing an interface operable to display a plurality of composite images, each composite image comprising one of the overlay renderings layered over its corresponding 2D rendering.

In another embodiment, a system for depicting on a display a multi-pose three-dimensional rendering of an object includes a database storing a multiplicity of two-dimensional renderings of the object. Each of the multiplicity of 2D renderings depicts the object from a different apparent viewing angle. The database also stores a multiplicity of overlay renderings, with each overlay rendering corresponding to a respective one of the multiplicity of 2D renderings. Further, each overlay rendering includes a shadow layer, rendered in a first color and corresponding to the visible shadows on the object as rendered in the corresponding 2D rendering, and a transparent background. The system further includes machine executable instructions stored on a machine readable medium and specifying an interface operable to display a plurality of composite images, each composite image comprising one of the overlay renderings layered over its corresponding 2D rendering. Still further, the system includes a server communicatively coupled to the database via a network and operable to send to a client device communicatively coupled to the network the machine instructions specifying the interface. The server is also operable to receive from the client device a request for the rendering of the object and, in response to the request, to retrieve the multiplicity of 2D renderings and the multiplicity of overlay renderings from the database and transmit the multiplicity of 2D renderings and the multiplicity of overlay renderings to the client device.

In still another embodiment, a machine-readable storage medium has stored thereon a set of machine executable instructions that, when executed cause a processor to receive from a server communicatively coupled to the processor by a network a multiplicity of 2D renderings. Each of the multiplicity of 2D renderings depicts a three-dimensional object from a different apparent viewing angle. The instructions also cause the processor to receive from the server a multiplicity of overlay renderings, each overlay rendering corresponding to a respective one of the multiplicity of 2D renderings. Each overlay rendering includes edge lines rendered in a first color and corresponding to the edges of the 3D object as rendered in the corresponding 2D rendering and a transparent background. Further, the instructions cause the processor to cause a display device coupled to the processor to display a plurality of composite images. Each composite image includes one of the overlay renderings layered over its corresponding 2D rendering.

In an embodiment, a method of depicting on a display a multi-pose three-dimensional rendering of an object includes storing on a computer readable medium an in image file. The image file stores data of a single image. The single image includes a multiplicity of portions, each of which includes a two-dimensional rendering of the object. Each of the 2D renderings depicts the object from a different apparent viewing angle. The method also includes transmitting the single image file via a network to a client device coupled to the display and providing a user interface operable to display, one at a time, the multiplicity of 2D renderings.

In another embodiment, a system for depicting on a display a multi-pose three-dimensional rendering of an object includes a database storing an image file. The image file stores data of a single image, and has a multiplicity of portions, each portion including a two-dimensional rendering of the object. Each of the two-dimensional renderings depicts the object from a different apparent viewing angle. The system also includes machine executable instructions stored on a machine readable medium and specifying interface operable to display the multiplicity of 2D renderings. Further, the system includes a server communicatively coupled to the database by a network. The server is operable to transmit to a client device communicatively coupled to the network the machine instructions specifying the interface. The server is also operable to receive from the client device a request for the rendering of the object and, in response to the request, to retrieve the image file from the database and transmit the image file to the client device.

In still another embodiment, a machine-readable storage medium has stored on it a set of machine executable instructions. When executed by a processor, the instructions cause the processor to receive from a server communicatively coupled to the processor by a network an image file. The image file stores data of a single image. The single image includes a multiplicity of portions, each portion including a two-dimensional rendering of a three-dimensional object. Each of the 2D renderings depicts the object from a different apparent viewing angle. The instructions are also operable to cause a display device coupled to the processor to display, one at a time, the multiplicity of 2D renderings.

In an embodiment, a method of depicting on a display a multi-pose three-dimensional rendering of an object includes storing on a computer-readable medium a multiplicity of two-dimensional renderings of the object. Each of the multiplicity of 2D renderings depicts the object from a different apparent viewing angle. The method also includes storing on the computer-readable medium a multiplicity of thumbnail images, each of which corresponds to a respective one of the multiplicity of 2D renderings. Further, the method includes transmitting the multiplicity of 2D renderings via a network to a client device coupled to the display, and transmitting the multiplicity of thumbnail images via the network to the client device. Still further, the method includes providing an interface operable to display each of the multiplicity of thumbnail images and, after the client device receives the 2D renderings to display each of the multiplicity of 2D renderings in place of the corresponding thumbnail image.

In another embodiment, a system for depicting on a display a multi-pose three-dimensional rendering of an object includes a database storing a multiplicity of two-dimensional renderings of the object. Each of the 2D renderings depicts the object from a different apparent viewing angle. The database also stores a multiplicity of thumbnail images, each of which corresponds to a respective one of the multiplicity of 2D renderings. The system also includes machine executable instructions stored on a machine readable medium. The instructions, when executed by a processor, implement a user interface operable to display the multi-pose 3D rendering. Further, the system includes a server communicatively coupled to the database via a network. The server is operable to transmit to a client device communicatively coupled to the network the multiplicity of 2D renderings and to transmit to the client device the multiplicity of thumbnail images. The user interface is operable to display each of the multiplicity of thumbnail images and, after the client device has received the 2D renderings, to display each of the multiplicity of 2D renderings in place of the corresponding thumbnail image.

In yet another embodiment, a machine-readable storage medium stores a set of machine executable instructions. When executed by a processor, the instructions cause the processor to receive from a server communicatively coupled to the processor by a first network a multiplicity of two-dimensional renderings of an object. Each of the multiplicity of 2D renderings depicts the object from a different apparent viewing angle. The instructions also cause the processor to receive from the server a multiplicity of thumbnail images. Each of the thumbnail images corresponds to a respective one of the multiplicity of 2D renderings. The instructions further cause a display device communicatively coupled to the processor to display each of the multiplicity of thumbnail images and, after full receiving the 2D renderings, display each of the multiplicity of 2D renderings in place of the corresponding thumbnail image.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment of thereof. Further, wherever possible, the following description refers to the reference numerals included in the following figures, in which features depicted in multiple figures are designated with consistent reference numerals.

FIG. 1 is a block diagram illustrating an exemplary embodiment of a system implementing a method in accordance with the presently described embodiments;

FIGS. 2A-2L depict, respectively, 12 exemplary displays showing a multi-pose 3D rendering of an object in accordance with the present description;

FIG. 3 illustrates an exemplary 2D rendering of an object;

FIG. 4 illustrates an exemplary edge-line overlay image for the corresponding rendering of FIG. 3;

FIG. 5 illustrates an exemplary composite image formed by layering the overlay image of FIG. 4 on the 2D rendering of FIG. 3;

FIG. 6 depicts a series of composite images such as that of FIG. 5, and the respective renderings layered to create the composite images;

FIG. 7 illustrates an exemplary 2D rendering of an object;

FIG. 8 illustrates an exemplary shadow overlay image for the corresponding rendering of FIG. 7;

FIG. 9 illustrates an exemplary composite image formed by layering the overlay image of FIG. 8 on the 2D rendering of FIG. 7;

FIG. 10 illustrates an exemplary image having a multiplicity of 2D rendering portions in accordance with the present description;

FIG. 11 illustrates in another form the dimensions of the exemplary image of FIG. 10;

FIG. 12 illustrates another exemplary image having a multiplicity of 2D rendering portions;

FIG. 13 depicts a web page in which a viewing application creates a user interface for displaying a multi-pose 3D rendering in accordance with the present description;

FIG. 14 is a block diagram depicting a method for improving speed and visual fidelity of a multi-pose 3D rendering by overlaying a second image;

FIG. 15 is a block diagram depicting a method, executed by a server, for improving the speed of a multi-pose 3D rendering by combining images;

FIG. 16 is a block diagram depicting a method, executed by a client device, for improving the speed of a multi-pose 3D rendering by combining images; and

FIG. 17 is a block diagram depicting a method for improving the speed of a multi-pose 3D rendering by preloading an optimized thumbnail view.

### DETAILED DESCRIPTION

In embodiments described below, a networked system permits one or more users to view a multi-pose 3D rendering of an object or model. The multi-pose 3D rendering is stored on one or more servers, which deliver the multi-pose 3D rendering to one or more client devices operating on a local area network (LAN) or a wide area network (WAN). A client device may be a workstation, a desktop computer, a laptop computer, a netbook computer, a tablet computer, a smart phone, a personal digital assistant, etc. The client device executes instructions for a viewing application to display the multi-pose rendering. The multi-pose 3D rendering may be a multiplicity of 2D renderings (which may be captured images of the model or object, or may be textured renderings of the model or object), each depicting the model or object from a different apparent viewing angle (pose). The 2D renderings are displayed sequentially so as to present an apparent 3D view of the model or object. By manipulation of user interface controls, the user may control the display of the various 2D renderings, thereby presenting the object or model from the angle desired by the user. For example, the user may view the object or model from different angles around a vertical axis extending through the model or object (referred to herein as “swiveling”) or around a horizontal axis extending through the model or object (referred to herein as “tilting”). Various techniques may be implemented to improve the speed and/or efficiency with which the multi-pose 3D rendering is depicted.

In some embodiments, an edge line overlay image is created for each of the series of the 2D renderings. Each overlay image includes a transparent background and a line drawing of the visible edges of the object or model in its current pose. When an edge line overlay image is superimposed on the corresponding 2D rendering to form a composite image, the composite image appears to a viewer to be a sharper image as a result of the well-defined edge lines.

In some embodiments, a shadow overlay image created for each of the series of the 2D renderings is a visible shadow rendering. Each shadow overlay includes a transparent background and a shadow image, which includes shadows appearing on the object in the 3D rendering. When the shadow overlay image is superimposed on the corresponding 2D rendering to form a composite image, the composite image appears to a viewer to be a sharper image as a result of the shadowing.

In some embodiments, the multiplicity of 2D renderings are sub-images (i.e., portions) of a single image file. The viewing application may receive or be programmed with parameters of the single image file, including the overall dimensions of the image and the number of 2D renderings in the multiplicity, and may sequentially display individual ones of the multiplicity of 2D renderings.

In some embodiments, the server transmits to the client, for each of the multiplicity of 2D renderings, a thumbnail image. The thumbnail images may be in a single image file or may be separate image files, but are transmitted in advance of the 2D renderings. Upon receipt of the thumbnail images, the viewing application displays the thumbnail images, optionally scaled up to the same dimensions as the 2D renderings. The thumbnail renderings are replaced on the display by the 2D renderings as or after downloading from the server is complete.

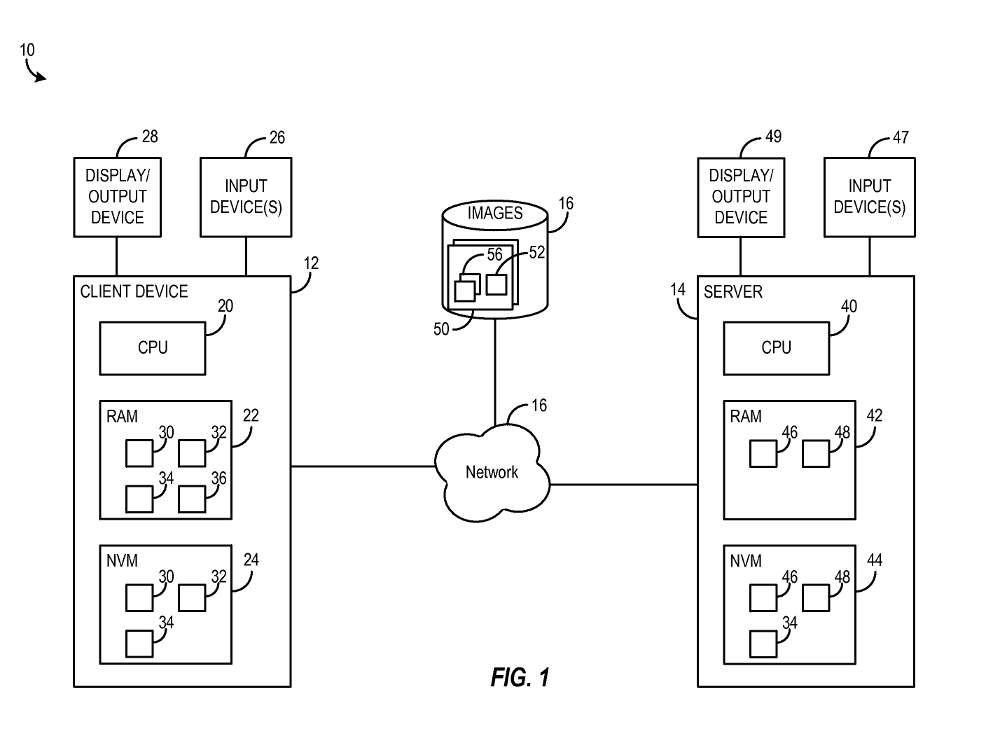

FIG. 1 depicts a block diagram of an embodiment of a system 10 on which the methods described herein may be implemented. The system 10 includes a client device 12, a server 14, a database 16, and a communication network 18 coupling the client device 12, the server 14, and the database 16. As described above, the client device 12 may be a workstation, a desktop computer, a laptop computer, a netbook computer, a tablet computer, a smart phone, a personal digital assistant, etc.

The client device 12 in some embodiments includes a central processing unit (CPU) 20 to execute computer-readable instructions, a random access memory (RAM) unit 22 to store data and instructions during operation, and non-volatile memory 24 to store software applications, shared software components such as Dynamic-link Libraries (DLLs), other programs executed by the CPU 20, and data. By way of example, the non-volatile memory 24 may be implemented on a hard disk drive (HDD) coupled to the CPU 20 via a bus. Alternately, the non-volatile memory 24 may be implemented as a solid state drive (not shown). Generally speaking, the components 20, 22, and 24 may be implemented in any suitable manner. For instance, while depicted in FIG. 1 as a single unit, the CPU 20 may be one or more processors in one or more physical packages, may be either a single-core or a multi-core processor, or may be a general processing unit and a graphics processor. Additionally, the CPU 20 may be split among one or more sub-systems of the client device 12, such as might be the case in a workstation having both a general purpose processor and a graphics subsystem including a specialized processor. Of course, the CPU 20 may be or include one or more field-programmable gate arrays (FPGAs), digital signal processors (DSPs), and/or application-specific integrated circuits (ASICs).

In the example implementation of FIG. 1, the client device 12 is a personal computer (PC). However, in general, the client device 12 may be any suitable stationary or portable computing device such as a tablet PC, a smart phone, etc. Although the client device 12 in the example of FIG. 1 includes both storage and processing components, the client device 12 in other embodiments can be a so-called thin client that depends on another computing device for certain computing and/or storage functions. For example, in one such embodiment, the non-volatile memory 24 is external to the client device 12 and is connected to the client device 12 via a network link. Further, the client device 12 may be coupled to an input device 26 and an output device 28. The input device 26 may include, for example, a pointing device such as a mouse, a keyboard, a touch screen, a trackball device, a digitizing tablet, or a microphone, and the output device 28 may include an LCD display monitor, a touch screen, or another suitable output device. Using the input device 26 and the output device 28, a user can access a graphical user interface (GUI) of the client device 12.

In operation, a user operating the client device 12 may use a browser application 30. In an embodiment, the browser application 30 is a stand-alone application stored in the non-volatile memory 24 and/or loaded into the RAM 22, and executable by the CPU 20. By way of programming incorporated into the browser 30 or implemented by a software plug-in 32 (i.e., a software component adding functionality to the browser application 30), the browser application 30 implements a viewing application 34 executable by the CPU 20. Specifically, the browser application 30 may implement an interpretation engine that can interpret and run small instruction sets (i.e., small programs) within the browser application 30. The instruction sets may be referred to throughout this application as applets. The applets may be received by the client device 12 as part of a web page 36 requested by the browser application 30 and, once downloaded, stored as a file 36 in the RAM 22 and/or in the non-volatile memory 24. As described below, an applet executed by the processor CPU 20 may cause the viewing application 34 to display on the display 28 a user interface for viewing and manipulating the multi-pose 3D rendering. The user interface implemented by the viewing application 34 may include a set of controls to rotate, tilt, zoom, sequentially select, and otherwise adjust the pose of the three-dimensional shape modeled or depicted in the multi-pose 3D rendering.

The server 14 implements many of the same components as the client device 12 including, for example, a central processing unit (CPU) 40 to execute computer-readable instructions, a random access memory (RAM) unit 42 to store data and instructions during operation, and non-volatile memory 44 to store software applications, shared software components such as Dynamic-link Libraries (DLLs), and other programs executed by the CPU 40, and data. By way of example, the non-volatile memory 44 may be implemented on a hard disk drive (HDD) coupled to the CPU 20 via a bus. Alternately the non-volatile memory 44 may be implemented as a solid state drive (not shown). Generally speaking, the components 40, 42, and 44 may be implemented in any suitable manner. For instance, while depicted in FIG. 1 as a single unit, the CPU 40 may be one or more processors in one or more physical packages, may be either a single-core or a multi-core processor, or may be a general processing unit and a graphics processor. Additionally, the CPU 40 may be split among one or more sub-systems of the server 14, such as might be the case in a workstation having both a general purpose processor and a graphics subsystem including a specialized processor. Of course, the CPU 40 may be or include one or more field-programmable gate arrays (FPGAs), digital signal processors (DSPs), and/or application-specific integrated circuits (ASICs).

Further, the server 14 may be coupled to an input device 47 and an output device 49. The input device 47 may include, for example, a pointing device such as a mouse, a keyboard, a touch screen, a trackball device, a digitizing tablet, or a microphone, and the output device 49 may include an LCD display monitor, a touch screen, or another suitable output device. Using the input device 47 and the output device 49, a user can access a graphical user interface (GUI) of the client device 14.

In operation, the server 14 may implement server software 46 stored in the non-volatile memory 44 and, when executed by the central processing unit 40, stored in the RAM 42. The server software 46, when executed by the CPU 40, may cause web pages 48 to be transmitted from the server 14 to the client device 12 via the network 18. In some embodiments, the web pages 48 may be stored in the non-volatile memory 44 and/or in the database 16, while in other embodiments, the server software 46 may cause the web pages 48 to be created according to information received from the client device 12, and stored in the RAM 42. The web pages 48 may be any web page implementing a display of a multi-pose 3D rendering including, by way of example and not limitation, a web page related to an online merchant or a web page related to a 3D modeling software application. The server 14 and, in particular, the non-volatile memory 44 or the RAM 42 may also store a program (i.e., machine executable instructions) for the viewing application 34, which may be transmitted to the client device 12 in response to a request for the viewing application 34 or as part of one of the web pages 48. The server 14 may also store models 48 that may be used by a 3D modeling application.

The database 16 may store, among other things, records 50 related to the multi-pose 3D renderings. In an embodiment, one or more of the records 50 includes a 3D model 52 that may be used by the 3D modeling application or in a 3D representation, such as a 3D map. The record 50 also includes a plurality of 2D renderings 54 for the model 52. Each of the renderings 54 depicts the object represented by the model 52 from a different angle. The number of renderings 54 associated with the record 50 may be any number greater than one, but is generally in a range of four to 40. In some embodiments, the renderings 54 may all depict the object represented by the model 52 from a similar or same elevation as the object is rotated. That is, 36 images may depict the object at 10 degree rotational differences from one image 54 to the next rendering 54. In other embodiments, the renderings 54 may depict the object represented by the model 52 from a number of rotational vantages at one elevation (i.e., swivel angles), from a number of different elevations (i.e., tilt angles), and/or from a number of rotational positions at each of several elevations, to provide a complete view of the object. In this manner, a user viewing the renderings (e.g., using the viewing application 34 operating on the client device 12) may be able to view the object without requiring the client device 12 to execute a software application that renders real-time 3D images. Instead, the user could “swivel” and/or “tilt” the object and see the object from any available angle, giving the user the illusion of interactive 3D when in fact nothing is changing aside from which of the 2D renderings is currently presented.

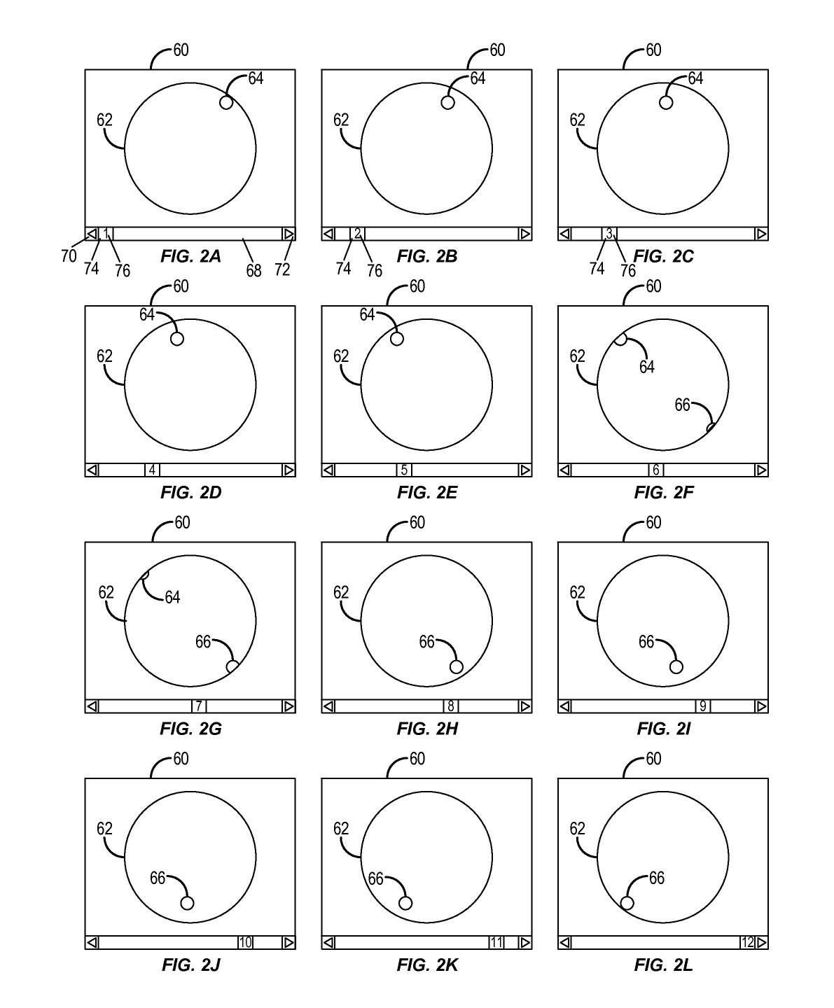

FIGS. 2A-2L illustrate an example of a display 60 such as might be displayed by display device 28 upon execution of the viewing application 34. The display 60 depicts a spherical 3D object 62 having two markers 64, 66 on it. A control bar 68 at the bottom of the display 60 allows a user to control the view of the object 62 by, for example, activating (e.g., “clicking” with a pointing device, such as a mouse, serving as the input device 26) controls 70 and 72 for selecting a previous or next image, respectively, or by moving a slider control 74. In the exemplary display 60 of FIGS. 2A-2L, the object 62 is depicted in 12 poses by 12 corresponding 2D renderings. Each of the corresponding 2D renderings depicts the object 62 from a single elevation, but rotated to a different angle. In each consecutive 2D rendering, the object 62 is rotated appears to have been rotated by an increment of 30 degrees (one twelfth of a full rotation). By viewing the 2D renderings in sequence, the object 62 appears to rotate in place so that the user can see the object 62 from different angles. In some embodiments, the slider 74 may include a numeric indicator 76 to show which of the 2D renderings is currently displayed. In some embodiments, the user may use the input device 26 to “click and drag” the object to rotate the object at interactive speeds. In some embodiments, the 12 2D renderings are in a highly compressed format to minimize the size of the associated file(s). In various embodiments, the 12 2D renderings may depict the object 62 in color or in grayscale.

Of course, it will be understood that while FIGS. 2A-2L depict an example embodiment in which a multi-pose rendering of the 3D object 62 is constructed using 12 2D renderings, the multi-pose rendering of the 3D object could be constructed from various numbers of 2D renderings from as few as three or four, to as many as 40 or more.

Regardless of the number of 2D renderings used to create the multi-pose 3D rendering, in a first aspect of the disclosed method and system, an overlay image is added to improve the visual fidelity of the multi-pose 3D rendering, even in instances in which the 2D renderings employ significant image compression. The overlay image contains a rendering of the edge lines that appear in each of the other 2D renderings. The overlay image is two-color image, having a transparent background (first color) and a one-color (second color) rendering of the edge lines. In an embodiment, the rendering of the edge lines is in black, though other colors may also be used, depending on, for example, the object being modeled (e.g., if the object being modeled is a very dark color—black, for instance—it might be preferable to use white to render the edge lines in the additional image).

The overlay image depicts not just the edge lines corresponding to a single one of the 2D renderings but, instead, depicts the edge lines corresponding to each of the other 2D renderings. Thus, referring again to the example illustrated in FIGS. 2A-2L, in which the multi-pose 3D rendering is accomplished via 12 2D renderings, the overlay image in an embodiment includes 12 edge-line renderings, each corresponding to one of the 12 2D renderings. Each of the 12 edge-line renderings has a specific location within the overlay image. The viewing application 34 executing on the client device 12 operates to display, for each of the 12 2D renderings, a corresponding portion of the overlay image to overlay the edge-line rendering over the 2D rendering.

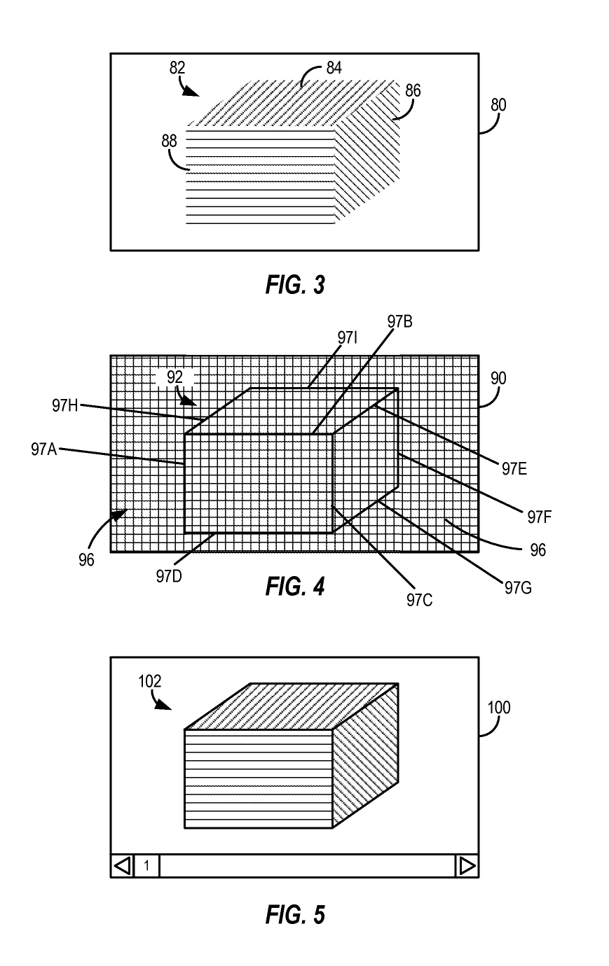

FIGS. 3-5 illustrate for a single 2D rendering how the concept of using an edge line overlay image operates. In FIG. 3, a single 2D textured rendering 80 depicts a rectangular 3D object 82. The textured rendering 80 may be one of a group of such images depicting the object 82 from a variety of angles such that, when the renderings are viewed sequentially, the renderings form a multi-pose 3D rendering of the object 82. In the textured rendering 80, the object 82 has three visible faces, 84, 86, and 88. Texturing of the faces 84, 86 and 88 are depicted in FIG. 3 by hatched lines in different orientations. FIG. 4 depicts a corresponding portion 90 of an edge line overlay image. The corresponding portion 90 includes an edge-line rendering 92 of the object 82, set on a transparent background 94 (indicated in FIG. 4 by hatching 96). Edge lines 97A-97D highlight the edges of the face 88, with edge lines 97B and 97C highlighting, respectively, the intersection of faces 88 and 84, and the intersection of faces 86 and 88. Similarly, edge lines 97E-97G, with edge line 97C highlight the edges of the face 86, with edge line 97E highlighting the intersection of faces 84 and 86. Edge lines 97H and 97I, with edge lines 97B and 97E highlight the edge of the face 84.

The viewing application 34, when executed by the CPU 20 of the client device 12 is operable to select the corresponding portion 90 of the overlay image, and to overlay the corresponding portion 90 over the 2D textured rendering 80. FIG. 5 shows a display 100 generated by the viewing application 34 as the viewing application 34 displays the composite image 102 generated by overlaying the 2D rendering 80 with the corresponding portion 90 of the edge-line rendering. That is, the 3D object 82 is depicted in the textured rendering 80, and the edge-line rendering portion 90 is layered on top of the rendering 80 such that the edge-lines 97A-97I align with the edges of the faces 84, 86, and 88 depicted in the rendering 80. Generally, this may be accomplished, in some embodiments, by creating the textured rendering 80 and the edge-line rendering portion 90 to have identical pixel dimensions (e.g., 400×400, 500×500, 400×300 etc.) such that each pixel of the textured rendering 80 has a corresponding pixel in the edge-line rendering portion 90 that is either a transparent color (i.e., does not change or obscure the corresponding pixel in the textured rendering 80) or an edge-line color (i.e., obscures the corresponding pixel in the textured rendering 80).

Advantageously, the resulting display 100 depicts the 3D object 82 in the sharper looking composite image 102 despite compression of the underlying rendering 80. Moreover, because the overlay image be saved in the GIF or PNG file format, and is only two-color, it allows for the maximum lossless compression. The LZW compression method used in both PNG and GIF file formats is particularly efficient at long, horizontal lines of the same color pixel. Accordingly, file size (and corresponding file transfer times) may be minimized. Further, in some embodiments, the edge line renderings of the overlay image may—perhaps selectively—be displayed without the underlying textured renderings, to present an edges only view (also referred to as a “wireframe” view). Additionally, in an embodiment, the overlay image is transferred to the client device 12 (i.e., downloaded by the client device 12) before the remaining 2D renderings, such that a user may manipulate (e.g., swivel) the object before the remaining 2D renderings have completely downloaded. In some embodiments, the transparency level of the overlay image and, specifically, of the edge line color is variable (e.g., with a slider control of the display application 34) to control how strongly the edges appear.

In some embodiments, the overlay image is created using scalable vector graphics (SVG) instead of rendered pixels to achieve the same or similar effect(s) as achieved with the overlay image saved in the GIF or PNG filed formats. It will also be understood that the overlay images, while described above as portions of a single image file, could each be individual files transmitted from the server 14 to the client device 12.

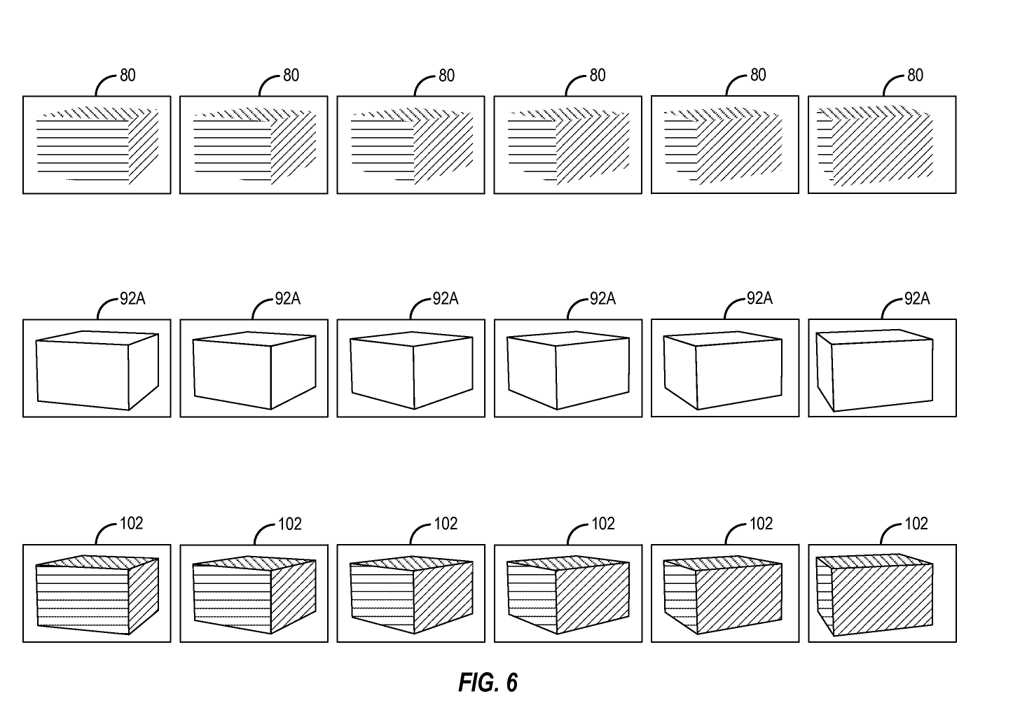

FIG. 6 illustrates the principle of the first aspect in operation in an embodiment in which each of the 2D renderings and each of the edge-line renderings is an image in an individual file. The top row of images in FIG. 6 depict a series of six textured renderings 80 that may be sequentially displayed by the viewing application 34 to create a multi-pose 3D rendering. The middle row of images in FIG. 6 depicts a series of six edge-line renderings 92A, each corresponding to the textured rendering 80 directly above it. The edge-line renderings 92A are depicted here separately as they might be if stored in individual files (as opposed to in a single file that is divided into the portions 90. The bottom row of images in FIG. 6 depicts a series of six composite images 102 that would result, respectively, from the layering of the textured rendering 80 in the top row with the edge-line rendering 92A in the middle row.

In a second aspect of the disclosed method and system, an overlay image is added to improve the visual fidelity of the multi-pose 3D rendering. The overlay image is a rendering of the shadows that appear in each of the other 2D renderings. Like the overlay image described above, the overlay image in the second aspect is a two-color image, having a transparent background and a one-color rendering of the shadows. In an embodiment, the rendering of the shadows is in black, though other colors may also be used as described above with respect to the edge lines.

In the second aspect, the overlay image depicts not just the shadows corresponding to a single one of the other 2D renderings but, instead, depicts the shadows corresponding to each of the other 2D renderings. As with the edge-line overlay image, the shadow overlay image includes 12 shadow renderings in the example embodiment of FIGS. 2A-2L, with each of the 12 shadow renderings corresponding to one of the 2D renderings. Each of the 12 shadow renderings has a specific location within the overlay image. The viewing application 34 executing on the client device 12 operates to display, for each of the 12 2D renderings, a corresponding portion of the overlay image to overlay the shadow rendering over the 2D rendering.

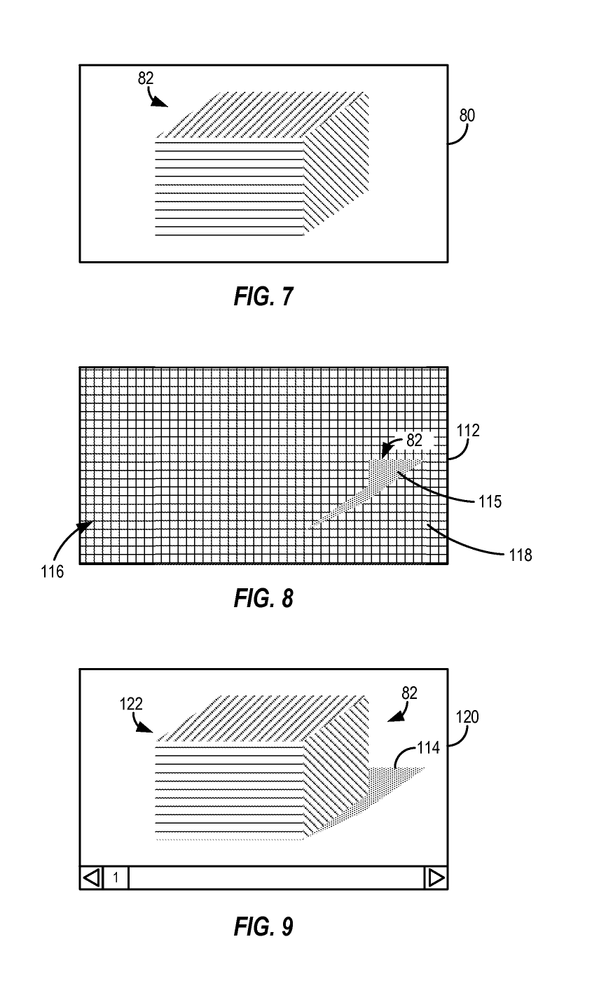

FIGS. 7-9 illustrate for a single 2D rendering how the concept of using a shadow overlay image operates. In FIG. 7, the single 2D textured rendering 80 (from FIG. 3) depicts the rectangular 3D object 82. Once again, the textured rendering 80 may be one of a group of such renderings depicting the object 82 from a variety of angles such that, when the renderings are viewed sequentially, the renderings form a multi-pose 3D rendering of the object 82. FIG. 8 shows a corresponding portion 112 of a shadow overlay image. The corresponding portion 112 includes a shadow rendering 114 of the object 82, set on a transparent background 116 (indicated in FIG. 8 by hatching 118). A shadow 115 is depicted in the corresponding portion 112 by a stippled field.

The viewing application 34, when executed by the CPU 20 of the client device 12 is operable to select the corresponding portion 112 of the overlay image, and to overlay the corresponding portion 112 over the 2D textured rendering 80. FIG. 9 shows a display 120 generated by the viewing application 34 as the viewing application 34 displays a composite image 120 generated by overlaying the 2D rendering 80 with the corresponding portion 112 of the shadow rendering. That is, the 3D object 82 is depicted in the textured rendering 80, and the shadow rendering portion 114 is layered on top of the rendering 80 such that the shadow 115 aligns with the rendering 80. Generally, this may be accomplished, in some embodiments, by creating the textured rendering 80 and the shadow rendering portion 114 to have identical pixel dimensions (e.g., 400×400, 500×500, 400×300 etc.) such that each pixel of the textured rendering 80 has a corresponding pixel in the shadow rendering portion 114 that is either a transparent color (i.e., does not change or obscure the corresponding pixel in the textured rendering 80) or a shadow color (i.e., darkens or obscures the corresponding pixel in the textured rendering 80).

Advantageously, the resulting display 120 depicts the 3D object 82 in the sharper looking composite image 122 despite compression of the underlying rendering 80. Moreover, because the overlay image be saved in the GIF or PNG file format, and is only two-color, it allows for the maximum lossless compression. Accordingly, file size (and corresponding file transfer times) may be minimized. In some embodiments, the transparency level of the overlay image and, specifically, of the shadow color is variable (e.g., with a slider control of the display application 34) to control how strongly the shadows appear.

In some embodiments, the overlay image is created using scalable vector graphics (SVG) instead of rendered pixels to achieve the same or similar effect(s) as achieved with the overlay image saved in the GIF or PNG filed formats.

While the overlay images described above are described as single images each of which includes areas therein corresponding to all of the 2D renderings of the multi-pose 3D rendering, it is possible (though, as will be understood, less efficient) to use a separate overlay image for each of the corresponding 2D renderings of the multi-pose 3D rendering.

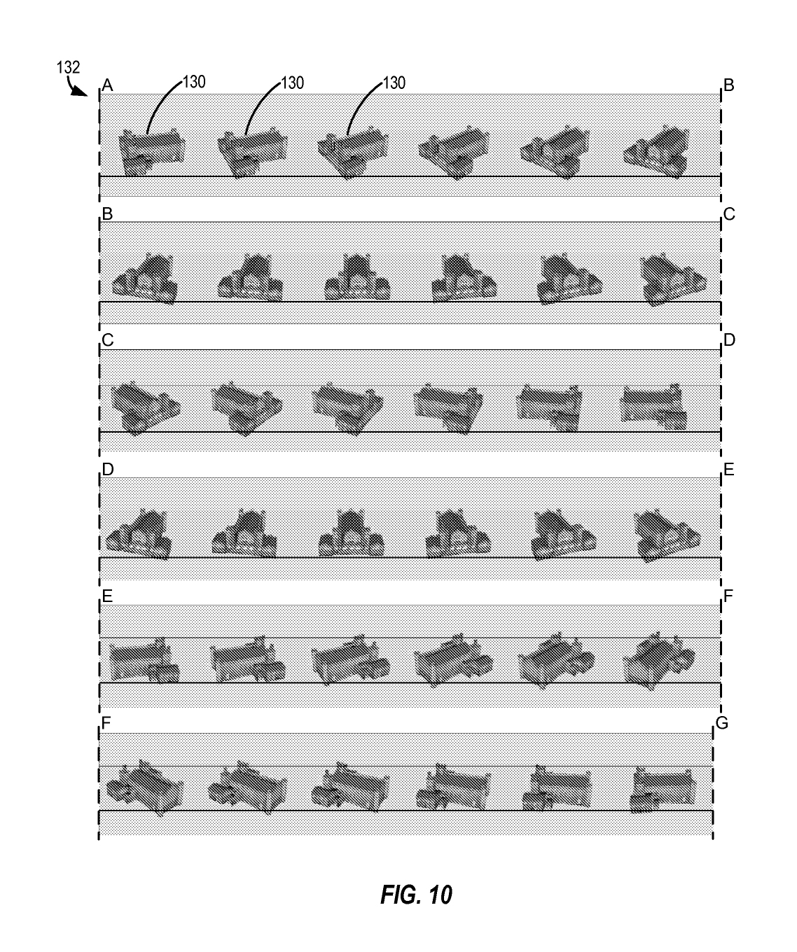

In a third aspect of the disclosed method and system, the time required to download the multi-pose 3D rendering is improved by combining the multiple 2D renderings into a single image file. With reference now to FIG. 10, an exemplary embodiment is depicted in which a multi-pose 3D rendering is created from 36 2D renderings 130. Of course, while the embodiment in FIG. 10 creates the multi-pose 3D rendering from the 36 2D renderings 130, other numbers of 2D renderings may be used, as was the case in the multi-pose 3D rendering depicted in FIGS. 2A-2L. In any event, in the embodiment of FIG. 10, the 36 2D renderings 130 are arranged horizontally in a single image 132 stored in a single file. In FIG. 10, the dashed lines A and G indicate the leftmost and rightmost edges of the single image 132, respectively, while the dashed lines B-F indicate contiguous boundaries of the image 132. That is, the dashed lines B line up, the dashed lines C line up, etc., such that the 36 2D renderings 130 would form the single horizontally-oriented image 132.

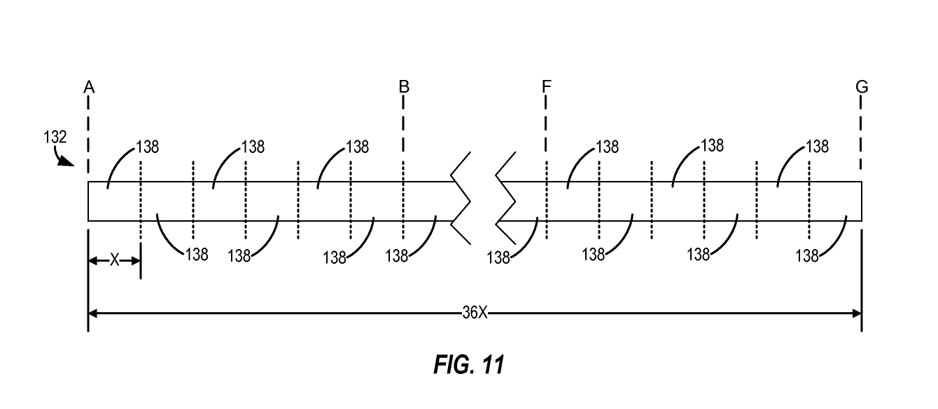

Thus, turning now to FIG. 11, the single file would store the single image 132. In the exemplary single image 132 depicted in FIG. 11, the single image 132 is divided into 36 portions 134, each of which corresponds to one of the 2D renderings. The portions 134 are aligned to span a single horizontal row; that is, the portions 134 are arranged as a row, and each of the portions 134 has a width equal to 1/36 of the total width of the single image 132. For example, if each portion 136 has a width of 500 pixels and a height of 375 pixels, then the total width of the single image 132 is 18,000 pixels (500×36) and the total height of the single image 132 is 375 pixels.

Thus, instead of having to request and download each of the 36 standalone 2D renderings, the viewing application 34 requests and downloads only the single image 132. As a result, the overhead in terms of file size and bandwidth are significantly decreased. Further, because many browsers have a download queue operable to download only 1-4 files at a time, the problem of downloading many individual images is eliminated in favor of downloading a single (albeit larger) image. Thus, in a particular instance of the example described above with reference to FIGS. 10 and 11, the method may decrease the download from 828 kB across 36 HTTP requests to 173 kB across a single request. This corresponds to approximately an 80% decrease in size.

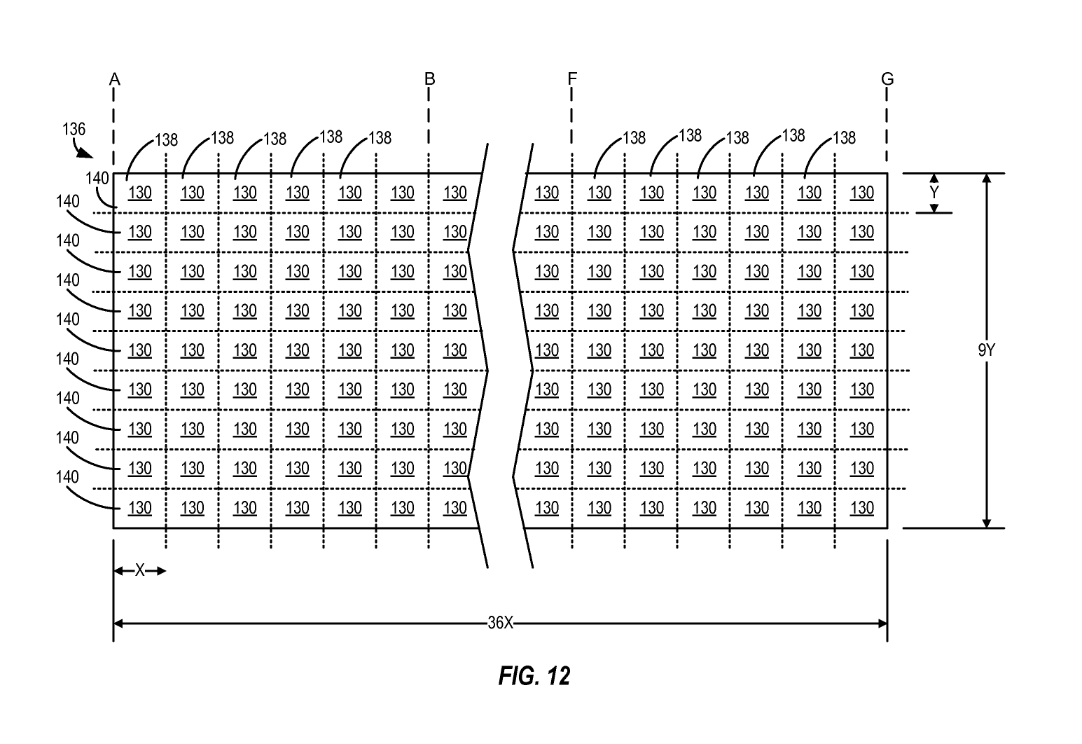

In some embodiments, the multi-pose 3D rendering may allow a viewer to tilt the object in addition to swiveling the object. Referring now to FIG. 12, a single image 136 may include portions 138 disposed horizontally across the image 136, for example corresponding to each of the 36 2D renderings 130 depicted in FIG. 10. As described above, viewing the 36 2D renderings 130 sequentially may allow the viewer to appear to swivel the object in the multi-pose 3D rendering. The single image 136 may also include, for each of the 36 2D renderings swiveling the object, portions 140 of the image that, collectively, allow the viewer to tilt the object in the multi-pose 3D rendering. In the embodiment depicted in FIG. 12, the portions 140 are arranged vertically down the image. The single image 136, for example, includes nine such portions 140 (“tilt portions”) for each of the 36 swivel positions (or, alternately stated, 36 swivel portions for each of the nine tilt positions), thereby allowing the viewer to view the object or model in the multi-pose 3D rendering from 324 different angles. The single image 136 would, in the example depicted in FIG. 12, have an overall size of 18,000 pixels (500×36) by 3,375 pixels (375×9). Of course, while the swivel positions and tilt positions are depicted in FIG. 12 as, respectively, horizontally and vertically arrayed in the image, the swivel positions and tilt positions could instead be arrayed vertically and horizontally, respectively.

In some embodiments, the single image 136 is stored as a file (e.g., at JPEG or PNG file) in a progressive format. When the single image 136 is being transferred to the client device 12, the user may be able to view and/or tilt and/or swivel a low quality view of the multi-pose 3D rendering before the transfer of the single image 136 is complete. This is an advantage over methods using individual renderings (e.g., the images depicted in FIGS. 2A-2L) because, in those methods, some of the renderings would finish downloading before others.

In a fourth aspect of the disclosed method and system, the multi-pose 3D rendering is previewed using a set of thumbnail images until the higher quality image(s) (e.g., the single image 136 or the set of 2D renderings described above) are transferred, and one of several strategies is employed to optimize (i.e., decrease) the time between the selection of the model or object to be represented in the multi-pose 3D rendering and the time that the user can start to manipulate (e.g., by swiveling or tilting) the multi-pose 3D rendering. In some embodiments, the thumbnail images may be rendered at a lower color bit depth than the 2D renderings that will make up the multi-pose 3D rendering. That is, while a “true-color” view (e.g., 24-bit color or higher) may be desired to capture the subtleties of texture and shading to make the multi-pose 3D rendering convincing, a lower bit depth may be used to render the thumbnail images. In embodiments, the thumbnail images may be rendered as 4-bit (16 colors) images or as 5-bit (32 colors) images, though higher and lower bit depths may be used. While there may be a decrease in quality, the quality will be acceptable for the preview, and the lower bit depth results in smaller images, thereby reducing the start up time before the user can manipulate the multi-pose 3D rendering.

In some embodiments, another strategy is used in addition to, or instead of, using a lower color depth. Instead of using the thumbnail images at their native size, the thumbnail images may be scaled up by the browser and/or viewing application. For example, if the multi-pose 3D rendering is 400×400 pixels, the thumbnails may be rendered at some smaller size, but scaled up to 400×400 pixels. By way of example and not limitation, the thumbnails may be rendered at 200×200 pixels, at 100×100 pixels, at 50×50 pixels, etc. This strategy is particularly advantageous when the thumbnail images require scaling up (i.e., zooming) by a power of 2, as many browsers are already equipped to scale images up in powers of 2. For this reason, thumbnail images rendered at 100×100 pixels (or 200×200 pixels) may be advantageous when previewing a multi-pose 3D rendering that will be 400×400 pixels, because the thumbnail images can easily be scaled by a factor of four (or two), while 250×250 pixel thumbnail images or 125×125 pixel thumbnail images—though they might work—would be more suited to a multi-pose 3D rendering that will be 500×500 pixels.

Further, in some embodiments, the thumbnail images may be scaled differently in one dimension than in the other. For example, each of the thumbnail images may be rendered using fewer pixels along the horizontal axis. The human eye and brain are adapted to compensating for “motion blur” when an object moves across the field of view, determining the shape of the blurred object. Taking advantage of this principle, the swiveling object or model may be rendered with fewer pixels along the axis of the swivel (i.e., the horizontal axis) without significantly affecting the perceived quality of the underlying image. For example, if the multi-pose 3D rendering is 400 pixels wide×400 pixels tall, the thumbnail images may be rendered as 50 pixels wide×100 pixels tall. The 50 left-to-right pixels will be stretched twice as much as the 100 top-to-bottom pixels, giving the illusion of motion blur, for which the viewer's eye will compensate. Additionally, these embodiments, like others, take advantage of the ability of LZW compression for compressing repeated horizontal pixels, reducing file size.

Additionally or alternatively, in some embodiments the thumbnails may be ganged up left-to-right in a single image, similar to the arrangement described above with respect to the 2D renderings forming the multi-pose 3D rendering, and depicted in FIGS. 10 and 11. As with the 2D renderings, the arrangement of the thumbnail images in a single image file and, in particular, from left-to-right, minimizes the number of HTTP requests (i.e., minimizes the number of files that must be downloaded and the corresponding overhead bandwidth) and takes advantage of the efficiency of the LZW compression method used in PNG and GIF images, which, in turn, further reduces file size.

Of course, the various aspects of described above may be used individually or in combination. By way of example and not limitation, in one embodiment, a multi-pose 3D rendering shows a modeled object that can be swiveled across 36 poses. That is, the multi-pose 3D rendering appears to show the object rotated in approximately 10 degree increments about a central vertical axis. Each pose of the multi-pose 3D rendering depicts the object in a 400 pixel×400 pixel image. The 36 2D renderings used to create the multi-pose 3D rendering are rendered in a single image file, with dimensions of 14,400 pixels×400 pixels. In other words, the 36 2D renderings in the single image file are arrayed left to right. An edge line overlay file includes 36 edge-line renderings, each corresponding to one of the 36 2D renderings and rendered in a single color on a transparent background. The 36 edge-line renderings are each 400×400 pixels, rendered in true color and, collectively, are arrayed left-to-right in a 14,400 pixel by 400 pixel image stored in a single image file. A shadow overlay file similarly includes 36 shadow renderings, each corresponding to one of the 36 2D renderings and rendered in a single color on a transparent background. The 36 shadow renderings are also each 400×400 pixels and, collectively, are arrayed left-to-right in a 14,400 pixel by 400 pixel image stored in a single image file. A thumbnail image file likewise includes 36 thumbnail images, each corresponding to one of the 36 2D renderings and rendered in a lower color depth and resolution than the 2D renderings. The 36 thumbnail images are each 50 pixels wide and 100 pixels high and, collectively, are arrayed left-to-right in an 1,800 pixel wide by 100 pixel high image stored in a single image file. As an additional advantage, the thumbnail image file may also be used to provide a smaller version of the multi-pose 3D rendering for use, for example, as a preview alongside search results.

In the exemplary embodiment, the four image files (thumbnails, edge-line renderings, shadow renderings, and 2D renderings) are transmitted from the server 14 to the client device 12. The edge-line overlay file may be transmitted first, followed by the thumbnails, then the shadow overlay file and, finally, the 2D renderings. The viewing application 34 may display the edge-line rendering first, fill it in with a scaled (i.e., zoomed) version of the thumbnails, add the shadows and, when the file containing the 2D renderings (i.e., the largest of the four files) has completed transferring, replace the thumbnails with the 2D renderings.

Of course, the exemplary embodiment described above is but a single embodiment, and many other combinations of the features described herein are possible.

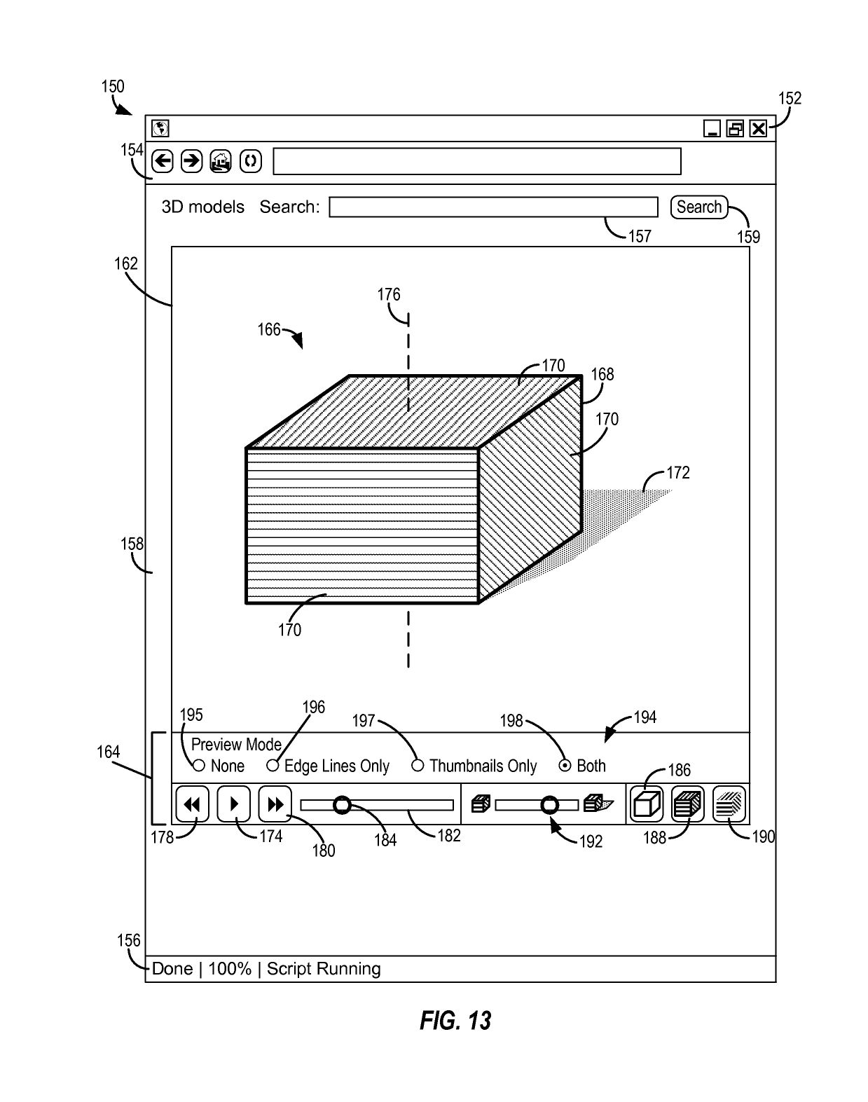

Turning now to the viewing application 34, the client device 12 must be capable of causing the display device 28 to display the multi-pose 3D rendering. As described above, the viewing application 34 may be executed by the CPU 20 as an applet running within the browser 30. The viewing application 34 causes a user interface to be displayed as a portion of a web page displayed in the web browser 30, in some embodiments. With reference to FIG. 13, a browser window 150, such as may be displayed by the display device 28 upon execution of the browser application 30 by the CPU 20, includes standard elements of many browsers, including a title bar 152, a navigation bar 154, a status bar 156, and a content window 158. Within the content window 158, various content may be displayed including properties of the model (not shown) and, in some embodiments, a search field 157 and associated search button 159 for allowing a user of the client device 12 to search for models and/or objects to display in a multi-pose 3D rendering. The content area 158 includes a user interface 160 generated by execution of the viewing application 34. The user interface 160 is divided into a rendering window 162 and a control area 164. The rendering window 162 displays a multi-pose 3D rendering 166 in accordance with a model or object selected by the user, and further in accordance with the status of various controls (described below) in the control area 164. For example, the multi-pose 3D rendering 166 may include rendered edge-lines 168, rendered surface shading 170, and rendered shadows 172.

The control area 164 may include various controls depending on the embodiment of the viewing application 34 and the specific implementation of the multi-pose 3D rendering 166. Generally, the control area 164 may include a “play” control 174, which may also serve as a “pause” control when the multi-pose 3D rendering 166 is in “play” mode. When in “play” mode, the multi-pose 3D rendering 166 may rotate about one or more axes. For example, by default, activation of the “play” control 174 may cause the multi-pose 3D rendering 166 to appear to rotate about an axis 176, which may or may not be displayed in the rendering window 162. The control area 164 may also include directional controls 178 and 180 that, respectively, cause the multi-pose 3D rendering to appear to rotate about the axis 176 in a reverse or forward direction. A slider bar 182 may have a control 184 that indicates and/or controls the selected pose of the multi-pose 3D rendering. That is, movement of the control 184 may cause the multi-pose 3D model 166 to rotate.

The control area 164 may also, depending on the embodiment, include one or more controls for manipulating the display qualities of the multi-pose 3D rendering 166. With reference still to FIG. 13, in an embodiment, the control area 164 includes an edge-line only control 186, an edge-and-texture control 188, and a texture-only control 190. The edge-line only control 186 causes the viewing application 34 to display in the rendering window 162 only the renderings in the edge-line overlay image. Similarly, the texture-only control 190 causes the viewing application 34 to display in the rendering window 162 only the renderings of the 2D images. The edge-and-texture control 188 causes the edge-line renderings to be layered over the 2D images. An additional control 192, which may be in the form of a slider bar may allow an additional layer and, in particular, the shadow renderings to be displayed in varying opacity, in the multi-pose 3D rendering 166.

In embodiments implementing a preview mode, the control area 164 may include one or more additional controls. In the embodiment depicted in FIG. 13, for example, the control area 164 includes a set of preview mode selection controls 194. The preview mode selection control are depicted in FIG. 13 as implemented using radio buttons, though it should be appreciated that the particular control type implemented is a matter of programmer choice. The preview mode controls 194 allow a user to select whether a preview mode is disabled (195), includes edge-lines only (196), thumbnails only (197), or both thumbnails and edge lines (198). It should be clear that the selection of the preview mode using the control 194 may affect the time required to fully download the multi-pose 3D rendering, the necessary bandwidth required to do so, and/or the number of files downloaded. For instance, if the control 195 is selected the viewing application 34 may cause only the 2D rendering(s) to be transmitted to the client device 12, and the multi-pose 3D rendering would be displayed when the 2D renderings were received (or when a portion of the image was received in the case of a single file in a progressive format). Alternately, if the control 196 is selected, the viewing application 34 may cause the edge line overlay image to be transmitted to the client device 12 in advance of the 2D renderings, and would present the edge-line renderings of the model or object while the 2D renderings were being transferred. As still another alternative, if the control 197 is selected, the viewing application 34 may cause the set of thumbnail images (preferably stored as a single image file) to be transmitted to the client device 12 in advance of the 2D renderings, and would present the thumbnail images (scaled up to the size of the 2D renderings) while the 2D renderings were being transferred. As yet another alternative, if the control 198 is selected, the viewing application 34 may cause the edge line overlay image and the set of thumbnail images (preferably stored as a single image file) to be transmitted to the client device 12 in advance of the 2D renderings, and would present the thumbnail images with the layered edge-line renderings while the 2D renderings were being transferred.

It should be apparent that the specific operation of the viewing application 34 will depend heavily upon the implementation. However, in view of this description, a person of skill in the programming arts should be able to implement the embodiments described herein with minimal experimentation. Depending on the embodiment, the viewing application 34 will be capable of performing one or more of the following: layering one or more images over one or more other images, including one or more images at least partially transparent; displaying as separate images multiple portions of a single image; magnifying (i.e., zooming) an image or a portion of an image; receiving a user input to select a layer of the layered one or more images to display; receiving a user input to select an image to display or a portion of an image containing multiple portions; receiving a user input to adjust a transparency characteristic of one or more images; sequentially displaying one or more images or layered combinations of images; displaying a scaled thumbnail image until a higher resolution image is available and then replacing the scaled thumbnail image with the higher resolution image.

The viewing application 34, at a minimum, is capable of sequentially displaying a multiplicity of 2D renderings (or photographs) depicting an object or model in varying poses, such that by the sequential display of the multiplicity of 2D renderings, the object or model appears to the user as a 3D rendering. In some embodiments, the viewing application 34 sequentially displays the multiplicity of 2D renderings as a loop of images (i.e., after displaying all of the multiplicity of 2D renderings, the viewing application 34 “loops” back to the first of the multiplicity of 2D renderings and displays all of the multiplicity of 2D renderings again). In some embodiments, the viewing application 34 is further capable of receiving user input to allow the viewer to manipulate the multiplicity of 2D renderings by pausing the sequential display of the 2D renderings, reversing the direction of the sequential display of the 2D renderings, and/or stepping through the sequential display of the 2D renderings.

Importantly for at least some aspects of the described method and system, the viewing application 34 will, in some embodiments, be capable of layering a first image and one or more overlay images to create a composite image. The first image may be, for example, one of the multiplicity of 2D renderings (e.g., the 2D textured rendering 80 depicted in FIGS. 3 and 7), while the overlay image may be an image having at least one transparent area. Specifically, the overlay image may be an edge-line rendering and/or a shadow rendering corresponding to the first image (e.g., as depicted in FIGS. 4 and 8). Layering the overlay image over the first image will result in enhanced visibility of the composite image due to the definition added to the first image by the edge line rendering or shadow rendering of the overlay image. The viewing application 34 may be capable of providing a composite image for each of the multiplicity of 2D renderings sequentially displayed, using a corresponding multiplicity of overlay images. In some embodiments, the layer or layers of the composite image may be selectable by one or more user inputs (e.g., buttons, sliders, toggle controls, etc.).

Additionally, for some aspects of the described method and system, the viewing application 34 will, in some embodiments, be capable of receiving as a single image file the multiplicity of sequentially displayed 2D renderings and/or the corresponding multiplicity of overlay images (e.g., the images layered on the multiplicity of 2D renderings to create the composite images). For example, the viewing application 34 may be capable of receiving the image 132 depicted by FIG. 11, and displaying, sequentially, each of the 36 portions 134. In some embodiments, the number of portions 134 may be hard coded in the viewing application 34, while in other embodiments, the viewing application 34 may receive as a parameter from, for example, the server 14, the number of portions 134. In any event, the viewing application 34 may be operable to determine the overall width of the image 132, and divide the width of the image 132 into the number of portions 134, displaying each of the portions 134 as the multiplicity of first images or as the corresponding multiplicity of overlay images. That is, either or both of the first images and/or the overlay images may be transmitted as a single file containing an image (e.g., the image 132) having multiple portions (e.g., the portions 134).

Further, in some embodiments, the viewing application 34 is able to request and/or receive first, a multiplicity of thumbnail images (as a single file or multiple files) and second, the multiplicity of 2D renderings forming the multi-pose 3D rendering. Specifically, the viewing application 34 may receive the thumbnail images and may scale each up to the full size of the multi-pose 3D rendering, display the thumbnails as a thumbnail multi-pose rendering in place of the 2D renderings that will eventually form the multi-pose 3D rendering, and enable the user to manipulate the thumbnail images multi-pose rendering while the 2D renderings are downloading. The viewing application 34 may replace the thumbnail images with the 2D renderings as each 2D rendering is completely downloaded or once all of the 2D renderings have completely downloaded.

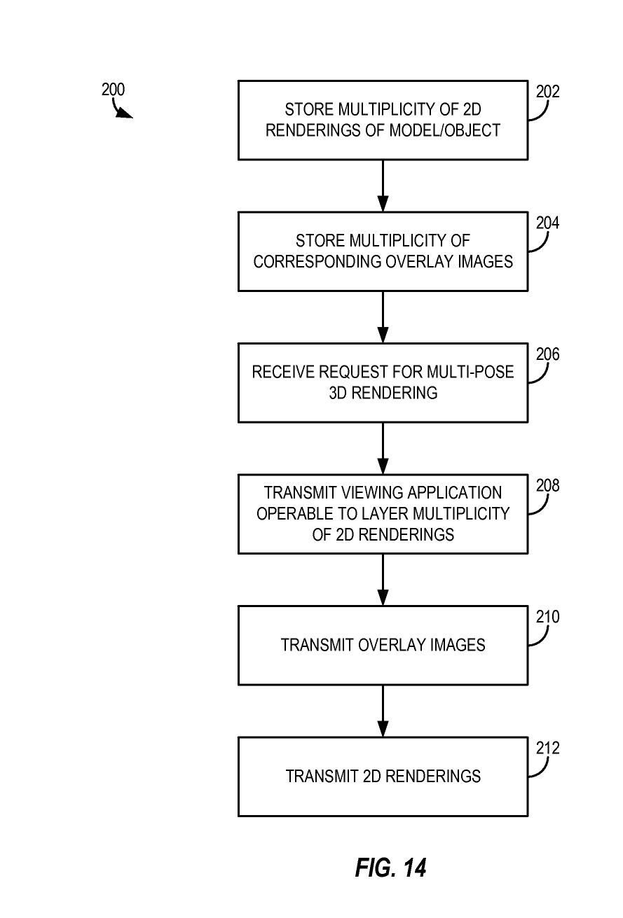

FIG. 14 depicts a method 200 that may be implemented by the server 14 to enable a user to view a multi-pose 3D rendering with increased visual fidelity. The server 14 and/or the database 16 may store a multiplicity of 2D renderings of a model or object (block 202). The server 14 and/or the database 16 may also store a multiplicity of corresponding overlay images (block 204), each overlay image for one of the multiplicity of 2D renderings and including an edge-line rendering, a shadow rendering, or both, set on a transparent background. The server 14 may, in some embodiments, transmit to the client device 12 a web page depicting a number of models or objects for which multi-pose 3D renderings exist. A user of the client device 12 may select one of the models or objects, causing the client device 12 to transmit a request for the corresponding multi-pose 3D rendering. The server 14, upon receiving the request for the multi-pose 3D rendering (block 206) may, in some embodiments transmit the viewing application 34 operable to sequentially display the multiplicity of 2D renderings with the layered overlay images (block 208). In embodiments in which the viewing application 34 is resident on the client device 12, the viewing application 34 need not be transmitted. In any event, the server 14 transmits the overlay images (block 210) and the 2D renderings (block 212) to the client device 12 for layering and display by the viewing application 34. Of course, whether the overlay images are transmitted before or after the 2D renderings is immaterial, unless the viewing application 34 will display the overlay images (e.g., in the case of an edge line overlay image) before transmission of the 2D renderings is complete.

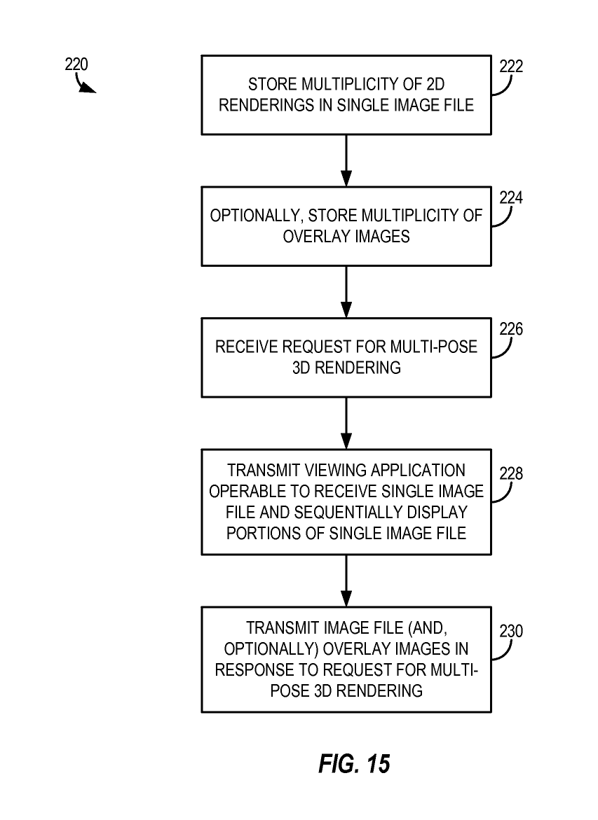

FIG. 15 depicts a method 220 that may be implemented by the server 14 for improving the speed of multi-pose 3D renderings by combining images. The server 14 and/or the database 16 may store in a single image file a multiplicity of 2D renderings of a model or object (block 222). Optionally, the server 14 and/or the database 16 may store, in a single image file or a multiplicity of image files, a multiplicity of overlay images (block 224), each overlay image for one of the multiplicity of 2D renderings and including an edge-line rendering, a shadow rendering, or both, set on a transparent background. The server 14 may, in some embodiments, transmit to the client device 12 a web page depicting a number of models or objects for which multi-pose 3D renderings exist. A user of the client device 12 may select one of the models or objects, causing the client device 12 to transmit a request for the corresponding multi-pose 3D rendering. The server 14, upon receiving the request for the multi-pose 3D rendering (block 226) may, in some embodiments, transmit the viewing application 34 operable to receive the single image file containing the 2D renderings and to sequentially display portions of the single image file (block 228). In embodiments in which the viewing application 34 is resident on the client device 12, the viewing application 34 need not be transmitted. In any event, the server 14 transmits the image file in response to the request for the multi-pose 3D rendering (block 230).

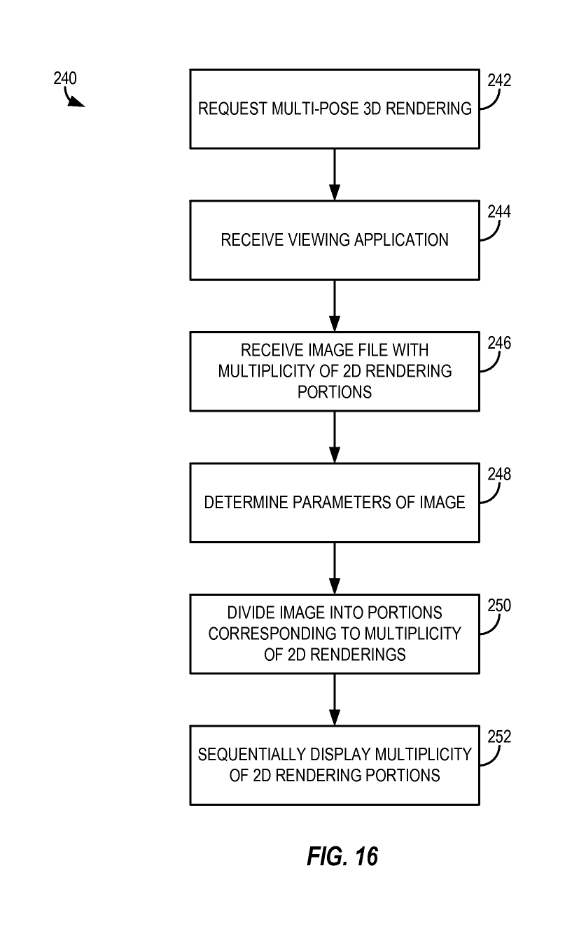

FIG. 16 depicts a method 240 that may be implemented by the client device 12 for improving the speed of multi-pose 3D renderings by combining images. The client device requests a multi-pose 3D rendering (block 244), for example, by receiving a user input selecting from a number of displayed models or objects for which multi-pose 3D renderings are available. The client device 12 receives, in some embodiments, the viewing application 34 operable to receive the single image file containing the 2D renderings and to sequentially display portions of the single image file (block 246). In embodiments in which the viewing application 34 is already resident on the client device 12, the block 246 may be omitted. The client device 12 receives the image file with the multiplicity of 2D rendering portions (block 246) and determines, from the image or from other parameters received from the server 13 with the image, one or more parameters of the image (block 248). The viewing application 34 divides the image into portions corresponding to the multiplicity of 2D renderings (block 250) and sequentially displays the multiplicity of 2D image portions (block 252). Of course, in various embodiments, the viewing application 34 may also receive one or more overlay images, may layer the overlay images on the portions of the single image file, may divide a single overlay image file into portions corresponding to the portions that include the 2D renderings, may receive thumbnail images prior to receiving the 2D renderings and display the thumbnail renderings while the 2D renderings are downloading, etc., as described throughout this description.

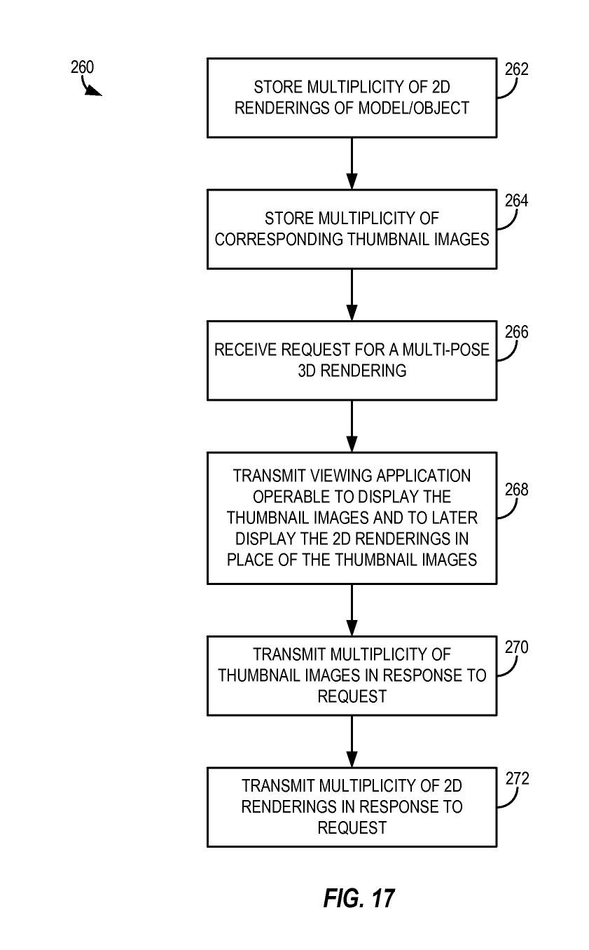

FIG. 17 depicts a method 260 that may be implemented by the server 14 for improving the speed of multi-pose 3D renderings by preloading an optimized thumbnail view. The server 14 and/or the database 16 may store a multiplicity of 2D renderings of a model or object (block 262). The server 14 and/or the database 16 may also store a multiplicity of corresponding thumbnail images (block 264), each thumbnail image for one of the multiplicity of 2D renderings. Each of the thumbnail images may be of a reduced color bit depth, may be a smaller resolution than the 2D renderings, and/or may be of a lower resolution in a horizontal dimension than in a vertical dimension. Additionally or alternatively, the thumbnail images may be combined into a single image file, as described above. The server 14 may, in some embodiments, transmit to the client device 12 a web page depicting a number of models or objects for which multi-pose 3D renderings exist. A user of the client device 12 may select one of the models or objects, causing the client device 12 to transmit a request for the corresponding multi-pose 3D rendering. The server 14, upon receiving the request for the multi-pose 3D rendering (block 266) may, in some embodiments transmit the viewing application 34 operable to display the thumbnail images while the multiplicity of 2D renderings are being transmitted (block 268). The server 14 may transmit the multiplicity of thumbnail images (as a single image file or multiple image files) in response to the request (block 270) and thereafter may transmit the multiplicity of 2D renderings (block 272).

Throughout this specification, plural instances may implement components, operations, or structures described as a single instance. Although individual operations of one or more methods are illustrated and described as separate operations, one or more of the individual operations may be performed concurrently and, unless specifically described or otherwise logically required (e.g., a structure must be created before it can be used), nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

For example, the network 16 may include but is not limited to any combination of a LAN, a MAN, a WAN, a mobile, a wired or wireless network, a private network, or a virtual private network. Moreover, while only one client device 12 is illustrated in FIG. 1 to simplify and clarify the description, it is understood that any number of client devices 12 are supported and can be in communication with the server 14.

Additionally, certain embodiments are described herein as including logic or a number of components, modules, routines, applications, or mechanisms. Applications or routines may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently or semi-permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments of a map editor system for purposes of illustration only. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for identifying terminal road segments through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention. By way of example, and not limitation, the present disclosure contemplates at least the following aspects:

1. A method of depicting on a display a multi-pose three-dimensional (3D) rendering of an object, the method comprising:

storing on a computer readable medium a multiplicity of two-dimensional (2D) renderings of the object, each of the multiplicity of 2D renderings depicting the object from a different apparent viewing angle;

transmitting the multiplicity of 2D renderings via a network to a client device coupled to the display;

storing on the computer readable medium a first multiplicity of overlay renderings, each of the first multiplicity of overlay renderings corresponding to a respective one of the multiplicity of 2D renderings and each overlay rendering comprising:

(1) either (a) a shadow layer, rendered in a first color and corresponding to shadows on the object as rendered in the corresponding 2D rendering; or (b) edge lines, rendered in a first color and corresponding to the edges of the object as rendered in the corresponding 2D rendering; and

(2) a transparent background;

transmitting the first multiplicity of overlay renderings via the network to the client device;

providing an interface operable to display a plurality of composite images, each composite image comprising one of the first multiplicity of overlay renderings layered over its corresponding 2D rendering.

2. The method according to aspect 1, wherein storing on the computer readable medium a first multiplicity of overlay renderings comprises storing a single image file, the file storing a single image, and further wherein each of the first multiplicity of overlay renderings forms a portion of the single image.

3. The method according to either aspect 1 or aspect 2, wherein the provided interface is further operable to provide a control for varying the transparency of the shadow layer.

4. The method according to any of the preceding aspects, further comprising:

transmitting a second multiplicity of overlay renderings, each of the second multiplicity of overlay renderings corresponding to one of the first multiplicity of overlay renderings and to the one of the multiplicity of 2D renderings, wherein the provided interface is further operable to sequentially display each of the multiplicity of first overlay renderings and each of the multiplicity of second overlay renderings as layers of a composite image including the corresponding 2D renderings.

5. The method according to any of the preceding aspects, wherein transmitting a second multiplicity of overlay renderings comprises transmitting a second single image file, the second single image file containing a second single image, and further wherein each of the second multiplicity of overlay renderings forms a portion of the second single image.

6. The method according to any of the preceding aspects, wherein the provided interface is selectively operable to sequentially display each of the multiplicity of 2D renderings instead of the corresponding composite images.

7. The method according to any of the preceding aspects, wherein providing an interface comprises providing an interface operable to display each of the multiplicity of the composite images in a pre-defined sequence.

8. The method according to any of the preceding aspects, wherein storing on the computer readable medium a multiplicity of overlay renderings comprises storing a single image file, the file storing a single image, and further wherein each of the multiplicity of overlay renderings forms a portion of the single image.

9. The method according to any of the preceding aspects, wherein the multiplicity of overlay renderings are arranged in the single image in order to correspond to the pre-defined sequence.

10. The method according to any of the preceding aspects, wherein transmitting the overlay renderings comprises transmitting the overlay renderings prior to transmitting the multiplicity of 2D renderings.

11. The method according to any of the preceding aspects, wherein the provided interface is further operable to sequentially display each of the multiplicity of overlay renderings before the plurality of 2D renderings is completely received by the client device.

12. The method according to any of the preceding aspects, wherein the provided interface is selectively operable to sequentially display each of the multiplicity of overlay renderings instead of the corresponding composite images.

13. A system for depicting on a display a multi-pose three-dimensional (3D) rendering of an object, the system comprising:

a database storing (1) a multiplicity of two-dimensional (2D) renderings of the object, each of the multiplicity of 2D renderings depicting the object from a different apparent viewing angle, and (2) a multiplicity of overlay renderings, each overlay rendering corresponding to a respective one of the multiplicity of 2D renderings and each overlay rendering comprising (i) either (a) a shadow layer, rendered in a first color and corresponding to the visible shadows on the object as rendered in the corresponding 2D rendering; or (b) edge lines, rendered in a first color and corresponding to the edges of the object as rendered in the corresponding 2D rendering and (ii) a transparent background;

machine executable instructions stored on a machine readable medium and specifying an interface operable to display a plurality of composite images, each composite image comprising one of the overlay renderings layered over its corresponding 2D rendering;

a server communicatively coupled to the database via a network and operable (1) to send to a client device communicatively coupled to the network the machine instructions specifying the interface and (2) to receive from the client device a request for the rendering of the object and, in response to the request, to retrieve the multiplicity of 2D renderings and the multiplicity of overlay renderings from the database and transmit the multiplicity of 2D renderings and the multiplicity of overlay renderings to the client device.

14. The system of aspect 13, wherein the multiplicity of overlay renderings is stored as a single image file, the single image file storing a single image, and further wherein each of the multiplicity overlay renderings forms a portion of the single image.

15. The system according to either aspect 13 or aspect 14, wherein the server is operable to transmit the overlay renderings prior to transmitting the multiplicity of 2D renderings.

16. The system according to any one of aspects 13 to 15, wherein the interface transmitted by the server is further operable to sequentially display each of the multiplicity of overlay renderings before the plurality of 2D renderings is completely received by the client device.

17. The system according to any one of aspects 13 to 16, wherein the interface transmitted by the server is selectively operable to sequentially display each of the multiplicity of overlay renderings instead of the corresponding composite images.

18. The system according to any one of aspects 13 to 17, wherein the interface transmitted by the server is selectively operable to sequentially display each of the multiplicity of 2D renderings instead of the corresponding composite images.

19. The system according to any one of aspects 13 to 18, wherein the interface transmitted by the server is further operable to display each of the multiplicity of images in a pre-defined sequence.

20. The system according to any one of aspects 13 to 19, wherein the multiplicity of overlay renderings is stored as a single image file, the single image file storing a single image, and further wherein each of the multiplicity overlay renderings forms a portion of the single image.

21. The system according to any one of aspects 13 to 20, wherein the multiplicity of overlay renderings are arranged in the single image in order to correspond to the pre-defined sequence.

22. The system according to any one of aspects 13 to 21, wherein the provided interface is further operable to provide a control for varying the transparency of the shadow layer.

23. The system according to any one of aspects 13 to 22, wherein the server is further operable to transmit a second multiplicity of overlay renderings, each of the second multiplicity of overlay renderings corresponding to one of the first multiplicity of overlay renderings and to the one of the multiplicity of 2D renderings, wherein the provided interface is further operable to sequentially display each of the multiplicity of first overlay renderings and each of the multiplicity of second overlay renderings as layers of a composite image including the corresponding 2D renderings.

24. The system according to any one of aspects 13 to 23, wherein the second multiplicity of overlay renderings is stored as a second single image file, the second single image file storing a second single image, and further wherein each of the second multiplicity overlay renderings forms a portion of the second single image.

25. A method of depicting on a display a multi-pose three-dimensional (3D) rendering of an object, the method comprising:

storing on a computer readable medium an image file, the image file storing data of a single image, the single image having a multiplicity of portions, each portion comprising a two-dimensional (2D) rendering of the object, each of the 2D renderings depicting the object from a different apparent viewing angle;

transmitting the single image file via a network to a client device coupled to the display; and

providing a user interface operable to display, one at a time, the multiplicity of 2D renderings.

26. The method according to aspect 25, wherein storing an image file comprises storing data of a single image having a multiplicity of portions, each portion extending a first number (X) of pixels in a horizontal dimension and a second number (Y) of pixels in a vertical dimension, the portions aligned in the single image such that the single image extends only Y pixels in the vertical direction.

27. The method according to either aspect 25 or aspect 26, wherein the portions are arranged such that the 2D renderings, when displayed sequentially, from a left-most portion of the single image to a right-most portion of the single image, appear to depict rotation of the object about an axis of the 3D object.

28. The method according to any one of aspects 25 to 27, wherein storing an image file comprises storing data of a single image having a multiplicity of portions, each portion extending a first number (X) of pixels in a horizontal dimension and a second number (Y) of pixels in a vertical dimension, the portions arranged in the single image such that:

portions arranged in the horizontal dimension, when displayed sequentially, from a left-most portion of the single image to a right-most portion of the single image, appear to depict rotation of the object about a first axis of the object; and

portions arranged in the vertical dimension, when displayed sequentially, from a top-most portion of the single image to a bottom-most portion of the single image, appear to depict the rotation of the object about a second axis of the object orthogonal to the first axis of the 3D object.

29. The method according to any one of aspects 25 to 28, further comprising:

storing on the computer readable medium an overlay image, the overlay image comprising a multiplicity of overlay renderings, each of the multiplicity of overlay renderings corresponding to one of the multiplicity of 2D renderings and comprising edge lines or shadows on a transparent background;

transmitting the overlay image to the client device via the network; and

displaying each of the multiplicity of overlay renderings over the corresponding one of the multiplicity of 2D renderings.

30. The method according to any one of aspects 25 to 29, wherein storing the single image file comprises storing the single image in a progressive image format.

31. The method according to any one of aspects 25 to 30, wherein providing a user interface operable to display, one at a time, the multiplicity of 2D renderings, comprises providing a user interface operable to commence displaying the multiplicity of 2D renderings before the single image is completely received from the server.

32. A system for depicting on a display a multi-pose three-dimensional rendering of an object, the system comprising:

a database storing an image file, the image file storing data of a single image, the single image having a multiplicity of portions, each portion comprising a two-dimensional (2D) rendering of the object, each of the 2D renderings depicting the object from a different apparent viewing angle;

machine executable instructions stored on a machine readable medium and specifying an interface operable to display the multiplicity of 2D renderings;

a server communicatively coupled to the database via a network and operable (1) to transmit to a client device communicatively coupled to the network the machine instructions specifying the interface and (2) to receive from the client device a request for the rendering of the object and, in response to the request, to retrieve the image file from the database and transmit the image file to the client device.

33. The system according to aspect 32, wherein the single image file comprises comprises a single image having a multiplicity of portions, each portion extending a first number (X) of pixels in a horizontal dimension and a second number of pixels (Y) in a vertical dimension, the portions aligned in the single image such that the single image extends only Y pixels in the vertical direction.

34. The system according to either aspect 32 or aspect 33, wherein the portions are arranged such that the 2D renderings, when displayed sequentially, from a left-most portion of the single image to a right-most portion of the single image, appear to depict rotation of the object about an axis of the object.

35. The system according to any one of aspects 32 to 34, wherein the single image file comprises a single image having a multiplicity of portions, each portion extending a first number (X) of pixels in a horizontal dimension and a second number (Y) of pixels in a vertical dimension, the portions arranged in the single image such that:

portions arranged in the horizontal dimension, when displayed sequentially, from a left-most portion of the single image to a right-most portion of the single image, appear to depict rotation of the object about a first axis of the object; and

portions arranged in the vertical dimension, when displayed sequentially, from a top-most portion of the single image to a bottom-most portion of the single image, appear to depict the rotation of the object about a second axis of the object orthogonal to the first axis of the object.

36. The system according to any one of aspects 32 to 35, wherein the database further stores (3) an overlay image, the overlay image comprising a multiplicity of overlay renderings, each of the multiplicity of overlay renderings corresponding to one of them multiplicity of 2D renderings and comprising edge lines or shadows on a transparent background;

wherein the server is further operable to (3) transmit the overlay image to the client device via the network; and

wherein the interface is further operable to display each of the multiplicity of overlay renderings over the corresponding one of the multiplicity of 2D renderings.

37. The system according to any one of aspects 32 to 36, wherein the image file comprises an image stored in a progressive image format.

38. The system according to any one of aspects 32 to 37, wherein the interface is further operable to commence displaying the multiplicity of 2D renderings before the single image is completely received from the server.

39. A machine-readable storage medium having stored thereon a set of machine executable instructions that, when executed, cause a processor to:

receive from a server communicatively coupled to the processor by a network an image file, the image file storing data of a single image, the single image having a multiplicity of portions, each portion comprising a two-dimensional (2D) rendering of a three-dimensional (3D) object, each of the 2D renderings depicting the 3D object from a different apparent viewing angle; and

cause a display device coupled to the processor to display, one at a time, the multiplicity of 2D renderings.

40. The storage medium of aspect 39, wherein the image file comprises data of a single image having a multiplicity of portions, each portion extending a first number (X) of pixels in a horizontal dimension and a second number (Y) of pixels in a vertical dimension, the portions aligned in the single image such that the single image extends only Y pixels in the vertical direction.

41. The storage medium of either aspect 39 or aspect 40, wherein the portions are arranged such that the 2D renderings, when displayed sequentially, from a left-most portion of the single image to a right-most portion of the single image, appear to depict rotation of the 3D object about an axis of the 3D object.

42. The storage medium of any one of aspects 39 to 41, wherein the image file comprises data of a single image having a multiplicity of portions, each portion extending a first number (X) of pixels in a horizontal dimension and a second number (Y) of pixels in a vertical dimension, the portions arranged in the single image such that:

portions arranged in the horizontal dimension, when displayed sequentially, from a left-most portion of the single image to a right-most portion of the single image, appear to depict rotation of the 3D object about a first axis of the 3D object; and

portions arranged in the vertical dimension, when displayed sequentially, from a top-most portion of the single image to a bottom-most portion of the single image, appear to depict the rotation of the 3D object about a second axis of the 3D object orthogonal to the first axis of the 3D object.

43. The storage medium of any one of aspects 39 to 42, wherein the instructions are further operable to cause the processor to:

receive from the server an overlay image comprising a multiplicity of overlay renderings, each of the multiplicity of overlay renderings corresponding to one of the multiplicity of 2D renderings and comprising edge lines or shadows on a transparent background;

display each of the multiplicity of overlay renderings over the corresponding one of the multiplicity of 2D renderings.

44. The storage medium of any one of aspects 39 to 43, wherein the image file is received in a progressive image format.

45. The storage medium of any one of aspects 39 to 44, wherein the instructions are further operable to cause the processor to display, one at a time, the multiplicity of 2D renderings before the single image is completely received from the server.

46. A method of depicting on a display a multi-pose three-dimensional (3D) rendering of an object, the method comprising:

storing on a computer-readable medium a multiplicity of two-dimensional (2D) renderings of the object, each of the multiplicity of 2D renderings depicting the object from a different apparent viewing angle;

storing on the computer-readable medium a multiplicity of thumbnail images, each of the thumbnail images corresponding to a respective one of the multiplicity of 2D renderings;

transmitting the multiplicity of 2D renderings via a network to a client device coupled to the display;

transmitting the multiplicity of thumbnail images via the network to the client device; and

providing an interface operable to display each of the multiplicity of thumbnail images and, after the client device has received the 2D renderings, display each of the multiplicity of 2D renderings in place of the corresponding thumbnail image.

47. The method according to aspect 46, wherein transmitting the multiplicity of thumbnail images occurs before transmitting the multiplicity of 2D renderings.

48. The method according to either aspect 45 or aspect 46, wherein storing a multiplicity of thumbnail images comprises storing a multiplicity of thumbnail images having a lower color depth than the 2D renderings.

49. The method according to any one of aspects 45 to 48, wherein storing a multiplicity of thumbnail images comprises storing a multiplicity of thumbnail images each having fewer pixels in at least one dimension than its corresponding 2D rendering.

50. The method according to any one of aspects 45 to 49, wherein storing a multiplicity of thumbnail images comprises storing a multiplicity of thumbnail images each having fewer pixels in a first dimension than in a second dimension.

51. The method according to any one of aspects 45 to 50, wherein displaying each of the multiplicity of thumbnail images comprises displaying each of the thumbnail images at the size of its corresponding 2D rendering.

52. The method according to any one of aspects 45 to 51, wherein the first dimension is orthogonal to an apparent axis of rotation about which the object appears to be rotated in the multiplicity of thumbnail images and the second dimension is parallel to the axis of rotation.

53. A system for depicting on a display a multi-pose three-dimensional (3D) rendering of an object, the system comprising:

a database storing (1) a multiplicity of two-dimensional (2D) renderings of the object, each of the multiplicity of 2D renderings depicting the object from a different apparent viewing angle and (2) a multiplicity of thumbnail images, each of the thumbnail images corresponding to a respective one of the multiplicity of 2D renderings;

machine executable instructions stored on a machine readable medium, the instructions, when executed by a processor, implementing a user interface operable to display the multi-pose 3D rendering;

a server communicatively coupled to the database via a network and operable (1) to transmit to a client device communicatively coupled to the network the multiplicity of 2D renderings and (2) to transmit to the client device the multiplicity of thumbnail images;

wherein the user interface is operable to display each of the multiplicity of thumbnail images and, after the client device has received the 2D renderings, display each of the multiplicity of 2D renderings in place of the corresponding thumbnail image.

54. The system according to aspect 53, wherein the server transmits the multiplicity of thumbnail images before it transmits the multiplicity of 2D renderings.

55. The system according to either aspect 53 or aspect 54, wherein each of the multiplicity of thumbnail images has a lower color depth than its corresponding 2D rendering.

56. The system according to any one of aspects 53 to 55, wherein each of the multiplicity of thumbnail images has fewer pixels in at least one dimension than its corresponding 2D rendering.

57. The system according to any one of aspects 53 to 56, wherein each of the multiplicity of thumbnail images has fewer pixels in a first dimension than in a second dimension.

58. The system according to any one of aspects 53 to 57, wherein the user interface is operable to display each of the multiplicity of thumbnail images at the size of its corresponding 2D rendering.

59. The system according to any one of aspects 53 to 58, wherein the first dimension is orthogonal to an apparent axis of rotation about which the object appears to be rotated in the multiplicity of thumbnail images and the second dimension is parallel to the axis of rotation.

60. A machine-readable storage medium having stored thereon a set of machine executable instructions that, when executed, cause a processor to:

receive from a server communicatively coupled to the processor by a network a multiplicity of two-dimensional (2D) renderings of an object, each of the multiplicity of 2D renderings depicting the object from a different apparent viewing angle;

receive from the server a multiplicity of thumbnail images, each of the thumbnail images corresponding to a respective one of the multiplicity of 2D renderings;

cause a display device communicatively coupled to the processor to display each of the multiplicity of thumbnail images and, after fully receiving the 2D renderings, display each of the multiplicity of 2D renderings in place of the corresponding thumbnail image.

61. The storage medium of aspect 60, wherein the instructions cause the processor to receive the multiplicity of thumbnail images before receiving the multiplicity of 2D renderings.

62. The storage medium of either aspect 60 or aspect 61, wherein the multiplicity of thumbnail images have a lower color depth than the 2D renderings.

63. The storage medium of any one of aspects 60 to 62, wherein each of the multiplicity of thumbnail images has fewer pixels in at least one dimension than its corresponding 2D rendering.

64. The storage medium of any one of aspects 60 to 63, wherein each of the multiplicity of thumbnail images has fewer pixels in a first dimension than in a second dimension.

65. The storage medium of any one of aspects 60 to 64, wherein the instructions are operable to cause the processor to display each of the thumbnail images at the size of its corresponding 2D rendering.

66. The storage medium of any one of aspects 60 to 65, wherein the first dimension is orthogonal to an apparent axis of rotation about which the object appears to be rotated in the multiplicity of thumbnail images and the second dimension is parallel to the axis of rotation.

1-66. (canceled)

67. A method of depicting on a display a multi-pose three-dimensional (3D) rendering of an object, the method comprising:
storing on a computer readable medium a multiplicity of two-dimensional (2D) renderings of the object, each of the multiplicity of 2D renderings depicting the object from a different apparent viewing angle;
transmitting the multiplicity of 2D renderings via a network to a client device coupled to the display;
storing on the computer readable medium a first multiplicity of overlay renderings, each of the first multiplicity of overlay renderings corresponding to a respective one of the multiplicity of 2D renderings and each overlay rendering comprising:
(1) either (a) a shadow layer, rendered in a first color and corresponding to shadows on the object as rendered in the corresponding 2D rendering; or (b) edge lines, rendered in a first color and corresponding to the edges of the object as rendered in the corresponding 2D rendering; and
(2) a transparent background;
transmitting, separately from the multiplicity of 2D renderings, the first multiplicity of overlay renderings via the network to the client device;
providing an interface operable to display a plurality of composite images, each composite image comprising one of the first multiplicity of overlay renderings layered over its corresponding 2D rendering.

68. The method according to claim 67, wherein storing on the computer readable medium a first multiplicity of overlay renderings comprises storing a single image file, the file storing a single image, and further wherein each of the first multiplicity of overlay renderings forms a portion of the single image.

69. The method according to claim 67, wherein the provided interface is further operable to provide a control for varying the transparency of the shadow layer.

70. The method according to claim 67, further comprising:
transmitting a second multiplicity of overlay renderings, each of the second multiplicity of overlay renderings corresponding to one of the first multiplicity of overlay renderings and to the one of the multiplicity of 2D renderings, wherein the provided interface is further operable to sequentially display each of the multiplicity of first overlay renderings and each of the multiplicity of second overlay renderings as layers of a composite image including the corresponding 2D renderings.

71. The method according to claim 70, wherein transmitting a second multiplicity of overlay renderings comprises transmitting a second single image file, the second single image file containing a second single image, and further wherein each of the second multiplicity of overlay renderings forms a portion of the second single image.

72. The method according to claim 67, wherein the provided interface is selectively operable to sequentially display each of the multiplicity of 2D renderings instead of the corresponding composite images.

73. The method according to claim 67, wherein providing an interface comprises providing an interface operable to display each of the multiplicity of the composite images in a pre-defined sequence.

74. The method according to claim 73, wherein storing on the computer readable medium a multiplicity of overlay renderings comprises storing a single image file, the file storing a single image, and further wherein each of the multiplicity of overlay renderings forms a portion of the single image.

75. The method according to claim 74, wherein the multiplicity of overlay renderings are arranged in the single image in order to correspond to the pre-defined sequence.

76. The method according to claim 67, wherein transmitting the overlay renderings comprises transmitting the overlay renderings prior to transmitting the multiplicity of 2D renderings.

77. The method according to claim 76, wherein the provided interface is further operable to sequentially display each of the multiplicity of overlay renderings before the plurality of 2D renderings is completely received by the client device

78. The method according to claim 67, wherein the provided interface is selectively operable to sequentially display each of the multiplicity of overlay renderings instead of the corresponding composite images.

79. A system for depicting on a display a multi-pose three-dimensional (3D) rendering of an object, the system comprising:
a database storing (1) a multiplicity of two-dimensional (2D) renderings of the object, each of the multiplicity of 2D renderings depicting the object from a different apparent viewing angle, and (2) a multiplicity of overlay renderings, each overlay rendering corresponding to a respective one of the multiplicity of 2D renderings and each overlay rendering comprising (i) either (a) a shadow layer, rendered in a first color and corresponding to the visible shadows on the object as rendered in the corresponding 2D rendering; or (b) edge lines, rendered in a first color and corresponding to the edges of the object as rendered in the corresponding 2D rendering and (ii) a transparent background;
machine executable instructions stored on a machine readable medium and specifying an interface operable to display a plurality of composite images, each composite image comprising one of the overlay renderings layered over its corresponding 2D rendering;
a server communicatively coupled to the database via a network and operable (1) to send to a client device communicatively coupled to the network the machine instructions specifying the interface and (2) to receive from the client device a request for the rendering of the object and, in response to the request, to retrieve the multiplicity of 2D renderings and the multiplicity of overlay renderings from the database and transmit the multiplicity of 2D renderings and the multiplicity of overlay renderings to the client device.

80. The system of claim 79, wherein the multiplicity of overlay renderings is stored as a single image file, the single image file storing a single image, and further wherein each of the multiplicity overlay renderings forms a portion of the single image.

81. The system according to claim 79, wherein the server is operable to transmit the overlay renderings prior to transmitting the multiplicity of 2D renderings.

82. The system according to claim 81, wherein the interface transmitted by the server is further operable to sequentially display each of the multiplicity of overlay renderings before the plurality of 2D renderings is completely received by the client device.

83. The system according to claim 79, wherein the interface transmitted by the server is selectively operable to sequentially display each of the multiplicity of overlay renderings instead of the corresponding composite images.

84. The system according to claim 79, wherein the interface transmitted by the server is selectively operable to sequentially display each of the multiplicity of 2D renderings instead of the corresponding composite images.

85. The system according to claim 79, wherein the interface transmitted by the server is further operable to display each of the multiplicity of images in a pre-defined sequence.

86. The system according to claim 85, wherein the multiplicity of overlay renderings is stored as a single image file, the single image file storing a single image, and further wherein each of the multiplicity overlay renderings forms a portion of the single image.
